(19) United States
(12) Patent Application Publication
(10) Pub. No.: US 2017/0178246 A1
(43) Pub. Date: Jun. 22, 2017

(54) DYNAMIC DATA NORMALIZATION AND DUPLICATE ANALYSIS

(71) Applicant: SpringAhead, Inc., San Francisco, CA (US)

(72) Inventors: Christopher Farrell, San Francisco, CA (US); Mark Milbourne, Walnut Creek, CA (US); Tyler Austen, Antioch, CA (US); Kevin Van Heusen, Ashland, OR (US); Claire Milligan, San Francisco, CA (US)

(21) Appl. No.: 15/368,616

(22) Filed: Dec. 4, 2016

Related U.S. Application Data
(60) Provisional application No. 62/269,065, filed on Dec. 17, 2015.

(51) Int. Cl. G06Q 40/00; G06F 17/30

(52) U.S. Cl. CPC G06Q 40/12; G06F 17/30303

(57) ABSTRACT

Methods and apparatuses for dynamic data normalization and duplicate analysis include normalizing data (e.g., merchant identifier data) received from a source entity (e.g., transaction card provider), as well as identifying and resolving potential duplicate transaction data objects based on one or more transaction characteristics. For example, data normalization includes partitioning an identifier into one or more merchant identifier portions, sending a merchant identifier request to a merchant database, and receiving a set of merchant representation candidates in response to sending the merchant identifier request. Further, for instance, duplicate analysis includes determining whether a transaction data object from the first set of transaction data objects that falls within the overlapping portion is not present in the second set of transaction data objects, and identifying the transaction data object within the second set of transaction data objects and the one or more non-overlapping portions.

### CLAIM OF PRIORITY

The present Application for Patent claims priority to U.S. Provisional Application No. 62/269,065 entitled “DYNAMIC DATA NORMALIZATION AND DUPLICATE ANALYSIS” filed Dec. 17, 2015, which is assigned to the assignee hereof and hereby expressly incorporated by reference in its entirety herein.

### BACKGROUND

The present disclosure relates generally to expense management, and more specifically to dynamic data normalization and duplicate analysis.

Expenses may have a variety of forms. In some instances, a direct payment to a merchant may be considered an expense, whereas in other instances, it may be common practice for an employee to pay for expenses out-of-pocket for later reimbursement. Because each expense is unique and subject to at least some form of audit, guidelines may be put into place to assist employees to provide accurate documentation of valid expenses in compliance with payment and reimbursement policies. Despite such efforts accounting errors may still occur. Some errors may be attributed to simple clerical errors, such as calculation errors, typographical errors, illegible handwriting, unwitting or unknowing duplicate submission of expenses, and so forth. Other errors may include classification errors, such as the use of incorrect account codes or incorrect department coding. In some cases, detection of the source of the errors may be problematic due, at least in part, to electronic accounting systems' ability to capture sufficient information for expense reporting. Accordingly, it may be desirable for improved transaction and/or expense management.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method relates to resolving a merchant identifier. The method may include receiving, at a network entity, the identifier having one or more characters. The method may further include partitioning, at the network entity, the identifier into one or more identifier portions according to one or more partitioning parameters. The method may further include sending an identifier request including the one or more identifier portions and a request instruction to a database storing a set of normalized identifiers. The method may further include receiving a set of representation candidates in response to sending the identifier request, the set of normalized identifiers include the set of representation candidates. The method may further include determining a correlation value for each representation candidate from the set of representation candidates, the correlation value represents a confidence level of an association between the identifier and a representation candidate. The method may further include determining whether at least one correlation value of the representation candidate satisfies a threshold value. The method may further include selecting the representation candidate based on determining that at least one correlation value of the representation candidate satisfies the threshold value. The method may further include forgoing selection of at least one representation candidate based on determining that at least one correlation value of the representation candidate does not satisfy the threshold value.

In another aspect, a computer-readable storage medium storing instructions executable by an electronic device may comprise at least one instruction for causing the electronic device to partition the identifier into one or more identifier portions according to one or more partitioning parameters. The computer-readable storage medium may comprise at least one instruction for causing the electronic device to send an identifier request including the one or more identifier portions and a request instruction to a database storing a set of normalized identifiers. The computer-readable storage medium may comprise at least one instruction for causing the electronic device to receive a set of representation candidates in response to sending the identifier request, the set of normalized identifiers include the set of representation candidates. The computer-readable storage medium may comprise at least one instruction for causing the electronic device to determine a correlation value for each representation candidate from the set of representation candidates, the correlation value represents a confidence level of an association between the identifier and a representation candidate. The computer-readable storage medium may comprise at least one instruction for causing the electronic device to determine whether at least one correlation value of the representation candidate satisfies a threshold value. The computer-readable storage medium may comprise at least one instruction for causing the electronic device to select the representation candidate based on determining that at least one correlation value of the representation candidate satisfies the threshold value. The computer-readable storage medium may comprise at least one instruction for causing the electronic device to forgo selection of at least one representation candidate based on determining that at least one correlation value of the representation candidate does not satisfy the threshold value.

In a further aspect, an apparatus relates to resolving a merchant identifier. The apparatus may include means for receiving the identifier having one or more characters. The apparatus may further include means for partitioning the identifier into one or more identifier portions according to one or more partitioning parameters. The apparatus may further include means for sending an identifier request including the one or more identifier portions and a request instruction to a database storing a set of normalized identifiers. The apparatus may further include means for receiving a set of representation candidates in response to sending the identifier request, the set of normalized identifiers include the set of representation candidates. The apparatus may further include means for determining a correlation value for each representation candidate from the set of representation candidates, the correlation value represents a confidence level of an association between the identifier and a representation candidate. The described apparatus may include means for determining whether at least one correlation value of the representation candidate satisfies a threshold value. The apparatus may further include means for selecting the representation candidate based on determining that at least one correlation value of the representation candidate satisfies the threshold value. The apparatus may further include means for forgoing selection of at least one representation candidate based on determining that at least one correlation value of the representation candidate does not satisfy the threshold value.

In another aspect, an apparatus relates to resolving a identifier. The apparatus may include a memory configured to store data, and at least one processor communicatively coupled to the memory, the at least one processor may be configured to receive the identifier having one or more characters. The at least one processor may further be configured to partition the identifier into one or more identifier portions according to one or more partitioning parameters. The at least one processor may further be configured to send an identifier request including the one or more identifier portions and a request instruction to a database storing a set of normalized identifiers. The at least one processor may further be configured to receive a set of representation candidates in response to sending the identifier request, the set of normalized identifiers include the set of representation candidates. The at least one processor may further be configured to determine a correlation value for each representation candidate from the set of representation candidates, the correlation value represents a confidence level of an association between the identifier and a representation candidate. The at least one processor may further be configured to determine whether at least one correlation value of the representation candidate satisfies a threshold value. The at least one processor may further be configured to select the representation candidate based on determining that at least one correlation value of the representation candidate satisfies the threshold value. The at least one processor may further be configured to forgo selection of at least one representation candidate based on determining that at least one correlation value of the representation candidate does not satisfy the threshold value.

In accordance with another aspect, a method of resolving one or more expense records at a network entity may include receiving, at the network entity, a set of transaction data objects including a first transaction data object from one or more first transaction sources, each transaction data object of the set of transaction data objects including one or more transaction characteristics. The method may further include determining, at the network entity, whether one or more transaction characteristics of the first transaction data object matches one or more transaction characteristics of a second transaction data object stored in a database of the network entity and received from one or more second transaction sources. The method may further include, in accordance with a determination that one or more transaction characteristics of the first transaction data object matches one or more transaction characteristics of the second transaction data object, adjusting one or more properties of a first expense record associated with the second transaction data object according to the one or more transaction characteristics of the first transaction data object. The method may further include, in accordance with a determination that one or more transaction characteristics of the first transaction data object does not match one or more transaction characteristics of the second transaction data object, generating a second expense record associated with the first transaction data object.

In another aspect, a computer-readable storage medium storing instructions executable by an electronic device, comprising at least one instruction for causing the electronic device to receive, at a network entity, a set of transaction data objects including a first transaction data object from one or more first transaction sources, each transaction data object of the set of transaction data objects including one or more transaction characteristics. The computer-readable storage medium further comprising at least one instruction for causing the electronic device to determine, at the network entity, whether one or more transaction characteristics of the first transaction data object matches one or more transaction characteristics of a second transaction data object stored in a database of the network entity and received from one or more second transaction sources. The computer-readable storage medium further comprising at least one instruction for causing the electronic device to, in accordance with a determination that one or more transaction characteristics of the first transaction data object matches one or more transaction characteristics of the second transaction data object, adjust one or more properties of a first expense record associated with the second transaction data object according to the one or more transaction characteristics of the first transaction data object. The computer-readable storage medium further comprising at least one instruction for causing the electronic device to, in accordance with a determination that one or more transaction characteristics of the first transaction data object does not match one or more transaction characteristics of the second transaction data object, generate a second expense record associated with the first transaction data object.

In a further aspect, an apparatus relates to resolving one or more expense records. The apparatus may include means for receiving, at a network entity, a set of transaction data objects including a first transaction data object from one or more first transaction sources, each transaction data object of the set of transaction data objects including one or more transaction characteristics. The apparatus may further include means for determining, at the network entity, whether one or more transaction characteristics of the first transaction data object matches one or more transaction characteristics of a second transaction data object stored in a database of the network entity and received from one or more second transaction sources. The apparatus may further include, in accordance with a determination that one or more transaction characteristics of the first transaction data object matches one or more transaction characteristics of the second transaction data object, means for adjusting one or more properties of a first expense record associated with the second transaction data object according to the one or more transaction characteristics of the first transaction data object. The apparatus may further include, in accordance with a determination that one or more transaction characteristics of the first transaction data object does not match one or more transaction characteristics of the second transaction data object, means for generating a second expense record associated with the first transaction data object.

In another aspect, an apparatus relates to resolving one or more expense records. The apparatus may include a memory configured to store data, and at least one processor communicatively coupled to the memory, the at least one processor are configured to receive, at a network entity, a set of transaction data objects including a first transaction data object from one or more first transaction sources, each transaction data object of the set of transaction data objects including one or more transaction characteristics. The apparatus may further determine, at the network entity, whether one or more transaction characteristics of the first transaction data object matches one or more transaction characteristics of a second transaction data object stored in a database of the network entity and received from one or more second transaction sources. The apparatus may further, in accordance with a determination that one or more transaction characteristics of the first transaction data object matches one or more transaction characteristics of the second transaction data object, adjust one or more properties of a first expense record associated with the second transaction data object according to the one or more transaction characteristics of the first transaction data object. The apparatus may further, in accordance with a determination that one or more transaction characteristics of the first transaction data object does not match one or more transaction characteristics of the second transaction data object, generate a second expense record associated with the first transaction data object.

In accordance with another aspect, a method relates to resolving an expense record. The method may include receiving, at a network entity within a network, a first set of transaction data objects associated with a first transaction window. The method may further include receiving, at the network entity, a second set of transaction data objects associated with a second transaction window that overlaps at least a portion of the first transaction window. The method may further include determining, at the network entity, whether a transaction data object from the first set of transaction data objects that falls within the overlapping portion is not present in the second set of transaction data objects. The method may further include, in accordance with a determination that the transaction data object from the first set of transaction data objects that falls within the overlapping portion is present in the second set of transaction data objects, transmitting the first transaction data object to an entity within the network. The method may further include adjusting one or more properties of the expense record associated with the transaction data object of the first set of transaction data objects based on one or more distinct characteristics of the transaction data object of the second set of transaction data objects

In another aspect, a computer-readable storage medium storing instructions executable by an electronic device, comprising at least one instruction for causing the electronic device to receive, at a network entity within a network, a first set of transaction data objects associated with a first transaction window. The computer-readable storage medium further comprises at least one instruction for causing the electronic device to receive, at the network entity, a second set of transaction data objects associated with a second transaction window that overlaps at least a portion of the first transaction window. The computer-readable storage medium further comprises at least one instruction for causing the electronic device to determine, at the network entity, whether a transaction data object from the first set of transaction data objects that falls within the overlapping portion is not present in the second set of transaction data objects. The computer-readable storage medium further comprises at least one instruction for causing the electronic device to, in accordance with a determination that the transaction data object from the first set of transaction data objects that falls within the overlapping portion is present in the second set of transaction data objects, transmit the first transaction data object to an entity within the network. The computer-readable storage medium further comprises at least one instruction for causing the electronic device to adjust one or more properties of an expense record associated with the transaction data object of the first set of transaction data objects based on one or more distinct characteristics of the transaction data object of the second set of transaction data objects.

In a further aspect, an apparatus relates to resolving an expense record. The apparatus may include means for receiving, at a network entity within a network, a first set of transaction data objects associated with a first transaction window. The apparatus may further include means for receiving, at the network entity, a second set of transaction data objects associated with a second transaction window that overlaps at least a portion of the first transaction window. The apparatus may further include means for determining, at the network entity, whether a transaction data object from the first set of transaction data objects that falls within the overlapping portion is not present in the second set of transaction data objects. The apparatus may further include, in accordance with a determination that the transaction data object from the first set of transaction data objects that falls within the overlapping portion is present in the second set of transaction data objects, means for transmitting the first transaction data object to an entity within the network. The apparatus may further include means for adjusting one or more properties of the expense record associated with the transaction data object of the first set of transaction data objects based on one or more distinct characteristics of the transaction data object of the second set of transaction data objects.

In another aspect, an apparatus relates to resolving an expense record. The apparatus may include a memory configured to store data, and at least one processor communicatively coupled to the memory, the at least one processor is configured to receive, at a network entity within a network, a first set of transaction data objects corresponding to a first transaction window. The at least one processor is further configured to receive, at the network entity, a second set of transaction data objects corresponding to a second transaction window that overlaps at least a portion of the first transaction window. The at least one processor is further configured to determine, at the network entity, whether a transaction data object from the first set of transaction data objects that falls within the overlapping portion is not present in the second set of transaction data objects. The at least one processor is further configured to, in accordance with a determination that the transaction data object from the first set of transaction data objects that falls within the overlapping portion is present in the second set of transaction data objects, transmit the first transaction data object to an entity within the network. The at least one processor is further configured to adjust one or more properties of the expense record associated with the transaction data object of the first set of transaction data objects based on one or more distinct characteristics of the transaction data object of the second set of transaction data objects.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### DESCRIPTION OF THE FIGURES

For a better understanding of the various described aspects, reference should be made to the description below, in conjunction with the following drawings in which like reference numerals refer to corresponding parts throughout the figures.

FIG. 1A is a block diagram illustrating a system for the collection, categorization, approval and delivery of expenses.

FIG. 1B is a block diagram for a module structure within a computer system for the collection, categorization, approval and delivery of expenses.

FIG. 2A is a block diagram of an expense processing and management system directed to normalization in accordance with some aspects of the present disclosure.

FIG. 2B is a block diagram of an expense processing and management system directed to duplicate determination in accordance with some aspects of the present disclosure.

FIG. 3A is a flow diagram for resolving an identifier in accordance with some aspects of the present disclosure.

FIG. 3B is a flow diagram for resolving an identifier in accordance with some aspects of the present disclosure.

FIG. 3C is a flow diagram for adjusting previously stored expense objects in accordance with some aspects of the present disclosure.

FIG. 3D is a flow diagram for comparing snapshots and locating duplicate transactions in accordance with some aspects of the present disclosure.

FIG. 3E is a flow diagram for comparing snapshots and locating duplicate transactions in accordance with some aspects of the present disclosure.

FIG. 4 is a functional block diagram of a network entity in accordance with some aspects of the present disclosure.

FIG. 5 is a functional block diagram of a network entity in accordance with some aspects of the present disclosure.

FIG. 6 is a functional block diagram of a network entity in accordance with some aspects of the present disclosure.

### DETAILED DESCRIPTION

The following description is presented to enable a person of ordinary skill in the art to make and use the various aspects. Descriptions of specific devices, modules, units, techniques, and applications are provided only as examples. Various modifications to the examples described herein will be readily apparent to those of ordinary skill in the art, and the general principles defined herein may be applied to other examples and applications without departing from the spirit and scope of the various aspects. Thus, the various aspects are not intended to be limited to the examples described herein and shown, but are to be accorded the scope consistent with the claims.

Portions of the following description may be presented in terms of functions, algorithms, flow diagrams/charts, logic blocks, and other symbolic representations of operations pertaining to physical properties that can be performed by a network entity or sophisticated computer system. A procedure, function, computer-executed step, logic block, process, etc., is here conceived to be a self-consistent sequence of one or more steps or instructions intended to manipulate physical quantities for practical results. These quantities may take the form of non-transitory signals (e.g. electrical, magnetic, optical, etc.) capable of being stored, transferred, combined, compared, and otherwise manipulated in a network entity or sophisticated computer system. These signals and information encoded therein may be referred to at times as bits, data, classes, datasets, data objects, parameters, values, elements, or the like. Each step and/or function may be performed by hardware, software, firmware, or any combinations thereof.

The present disclosure generally relates to dynamic data normalization and duplicate analysis. Expense management may involve the processing of large numbers of expense or transaction data objects. For example, a centralized computer system in the form of a network entity may store a plurality of user accounts. Each user account may in turn include or otherwise be associated with one or more expense or transaction data objects. As one or more expense or transaction data objects are processed and/or managed for a particular user account, the processing or management may be performed based on or otherwise using systems, methods, or procedures that are consistent and non-adaptive and/or non-dynamic. In other words, the network entity may not “learn” or otherwise adaptively determine various behaviors, parameters, and/or patterns for a particular user during the iterative expense processing and/or management. As such, it may be beneficial for an adaptive system that may form or otherwise tailor a unique expense management procedure to individual users based on, for instance, a history of received expense or transaction data objects would be beneficial to the processing, reporting, and management of expenses.

For example, a complete and accurate recording (e.g., storing) of expenses or transactions often involves numerous complexities. In the simplest cases, a recording may include precise mapping of expenses to appropriate accounts and related reporting attributes (e.g., accounting system classifications, company departments, office locations, etc.) that may draw from a combination of accounting expertise and context of an expense (e.g., project name, a department to which an expense applies, etc.).

Further, and more specifically, the present aspects relate to the normalization of data items such as one or more transaction data objects and the duplicate analysis of such transaction data objects for improved expense or transaction data object data management. For example, some expense or transaction data systems may receive large amounts of data including, but not limited to, transaction data objects related to one or more expenses or transactions. However, effective management of such transaction data objects by such systems may be limited. For instance, some transaction data objects may include identifiers such as, but not limited to, merchant identifiers or names that refer to one or more particular merchants. In some instances, however, two or more transaction data objects may include distinct merchant identifiers referring to or associated with the same merchant. In such instance, distinct merchant identifiers may lead to conflicting transaction data objects and result in processing delays and errors.

Further, in some instances, a transaction data object may be received that appears to be different from another (stored) transaction data object, when in fact the transaction data objects are associated with or otherwise related to the same transaction. However, the transaction data objects include one or more transaction characteristics that may indicate whether the transactions data objects are in fact the same or distinct. As such, the inability of such systems to identify and resolve such duplication may result in inefficient data storage management, decreased transaction management accuracy (both overall within the system and per user), and increased transaction data object processing times. Accordingly, it would be desirable to provide systems, apparatuses, and/or methods that effectively and efficiently normalizes data such as merchant identifiers, as well as determining and resolving duplicate transaction data objects.

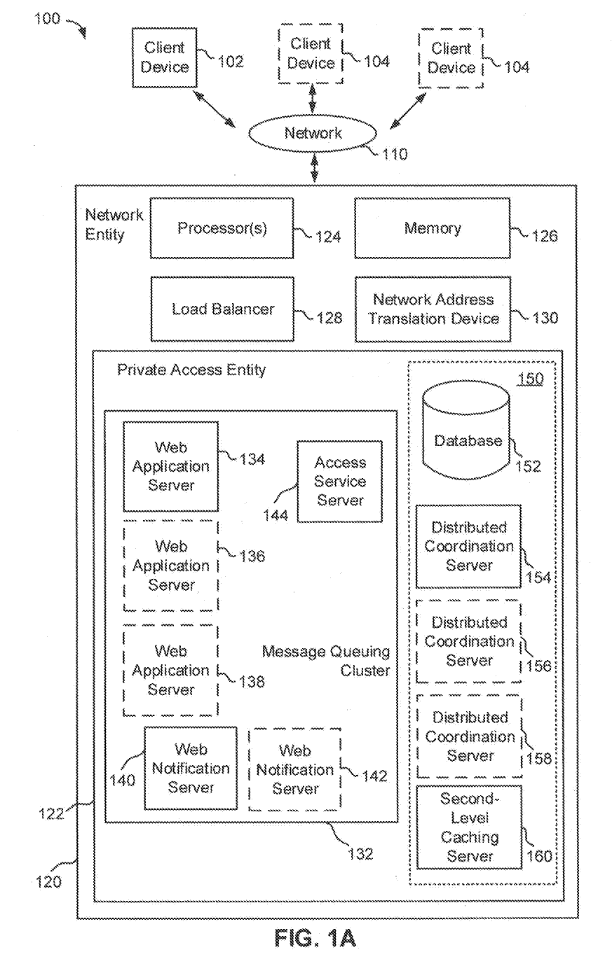

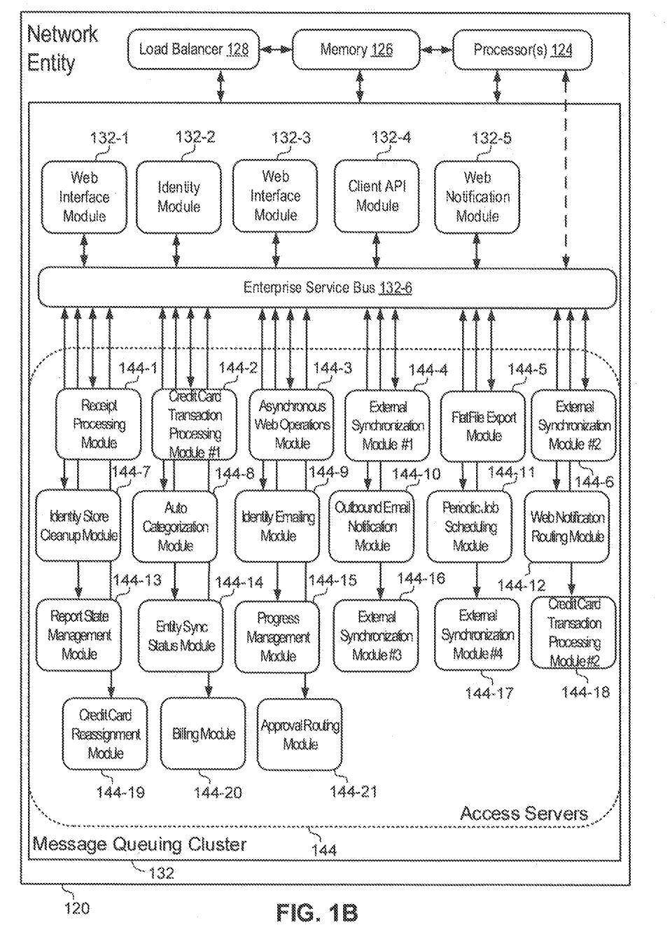

Referring to FIG. 1A, a communication system 100 for managing and/or processing expenses includes one or more client devices in communication with a network entity 120. In some aspects, network entity 120 may be configured to manage transaction or expense processing and analysis including dynamic data normalization and duplicate analysis to reduce the likelihood of errors during or as part of the collection, categorization, approval, and delivery of the expenses. In some aspects, expenses may be referred to or take the form of expense and/or transaction data objects. Specifically, in some aspects, an expense and/or transaction data object may be a representation of structured or unstructured data related to expense information. Expense information may include one or more of receipt data, invoice data, billing data, statement data, or tax data. For example, communication system 100 may include client devices 102, 104 and/or 106, network entity 120, and network 110. The client computing devices 102, 104, and 106 may each be an electronic device having at least a processing unit and associated with a user. For example, client devices 102, 104, and/or 106 may be a desktop computer 102, a laptop 104, mobile device 106.

Further, it should be appreciated that mobile devices 102, 104, and/or 106 may include or otherwise be a portable electronic communications and computing device such as a ‘smartphone,’ ‘tablet,’ wearable computing device, and the like. It should also be appreciated that the total number of client computing devices will vary and may be less or more than the number illustrated in FIG. 1A. In particular, the number of client computing devices may be based on the number of clients and devices configured by each client as a client device. For instance, the total number of client devices may be expanded to five for the two clients when: a first client has three mobile device configured as client computing devices 102, 104, and 106 and a second client has a laptop and ‘tablet’ computer.

Network entity 120 may include one or more components, servers, and/or modules, each of which may be configured, in a synchronous or asynchronous manner, to process, manage and report expense information. Network entity 120 may be a remote based infrastructure with shared resources, software, and information provided to client devices 102, 104, and/or 106 and accessible using or via network 110. In some aspects, the one or more servers and/or modules may be referred to as electronic access devices. In some aspects, the remote based infrastructure may be a network of remote servers hosted on the Internet and used to store, manage, and process data in place of local servers or personal computers. For example, the remote based infrastructure may also be referred to as a cloud based infrastructure. Network entity 120 may include one or both of physical servers or virtual servers housed within private server cluster 122. The private server cluster 122 may be hosted and managed internally or externally. The private server cluster 122 may be a ‘private cloud’ that includes a network accessible infrastructure.

Network 110 may utilize one or more communication mediums and protocols and may include one or more computer or data networks such as the Internet or an intranet. Client devices 102, 104, and 106, as well as network entity 120, may be coupled to, connected to or otherwise in communication with network 110 using, any combination of, wired connections, wireless connections, Wi-Fi, Ethernet, Bluetooth, cellular, fiber optic, spread spectrum technologies, or other suitable communication technology enabling or facilitating communication between electronic devices.

Network entity 120 may include load balancer 128 and network address translation device 130 coupled to or otherwise in communication with private access entity 122. Load balancer 128 may be configured to distribute the computational workload over one or more modules and/or servers in private access entity 122 based on a specific function each module and server performs. In some instances, load balancer 128 may be configured to distribute the computational workload to web interface module 132-1, identity module 132-2, web interface module 132-3, client application program interface (API) module 132-4, and web notification module 132-5 may be coupled to or connected to the enterprise service bus 132-6 as depicted in FIG. 1B. In some instances, load balancer 128 may control an incoming (e.g., downlink) and outgoing (e.g., uplink) transmission of data packets (e.g., web traffic/data) to/from network entity 120.

Network address translation device 130 may be configured to modify network address parameters in Internet Protocol (IP) packets as they transit in and out of network entity 120. In some instances, network address translation device 130 may be configured to map/remap an IP address space between network entity 120 and client computing devices 102, 104, and/or 106, as well as other external computing devices not shown in FIG. 1A. Network address translation device 130 may also be configured so that some or all outbound IP traffic from the private access entity 122 passes through network address translation device 130.

Further, private access entity 122 may include message queuing cluster 132 and one or more additional databases and/or servers 150. Specifically, message queuing cluster 132, which may be configured to monitor and/or manage a list of data items and/or commands stored so as to be retrievable in a definite order (e.g., in the order of insertion), may include web application servers 134, 136, 138, access service modules/servers 144, and web notification servers 140 and 142.

Web application servers 134, 136, and 138 may be configured to respond to hypertext transfer protocol secure (HTTPS) requests for interfaces to network entity 120. Web browser interfaces and application program interface (API) related functionality may be provided. Web notification servers 140 and 142 may be configured to provide a browser communication channel for real-time adjustments/updates to a web browser application interface for network entity 120. It should be appreciated that one or more web notification servers, as depicted in FIG. 1A, may be present to optimize throughput. The access service modules 144 may be configured to provide backend processing, which may include expense processing and real-time synchronization with target accounting systems. Additionally, message queuing cluster 132 may be configured as a scalable architecture for additional web applications, web notifications, and service modules.

The one or more additional servers 150 may include database 152, distributed coordination servers 154, 156, and 158 and second-level caching server 160. In some aspects, the one or more additional servers 150 may include one or more databases including database 152. Database 152 may be a storage media, such as, but not limited to, magnetic storage media, optical storage media, hard disk drives (HDD), solid state drive (SSD), virtual storage devices, and the like. Database 152 may be integrated into private access entity 122 to provide central data storage of parameters for the servers of server infrastructure 20.

Distributed coordination servers, 154, 156, and 158, may be configured to provide a configuration and distributed locking module mechanism utilized by one or more access service modules 144 in message queuing cluster 132. Second level caching server 160 may be configured to cache one or more parameters between the servers of the private access entity 122 and the one or more databases 152 in order to increase the speed and overall throughput. It should be appreciated that the number of servers in the additional servers 150 may vary in order to accommodate and optimize throughput of the private access entity 122; for example, additional databases 152 may be added to accommodate for more storage. In some aspects, access service modules 144, web applications servers 134, 136, and 138, and web notification servers 140 and 142, of the message queuing cluster 132 may be coupled to or otherwise in communication with a bus (e.g., enterprise service bus 132-6, FIG. 1B).

In some aspects, network entity 120 and/or each one of the modules, servers, and/or components of network entity 120 may include one or more processors 124. Examples of processors 124 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In some aspects, the modules may each be hardware modules. One or more processors 124 may be implemented with a “processing system” to execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Further, in some aspects, network entity 120 and/or each one of the modules, servers, and/or components of network entity 120 may include memory 126, which may be or otherwise take the form of one or more computer-readable storage mediums for storing computer-executable instructions that when executed by one or more computer processors, for example, can cause the computer processors to perform the techniques described herein. The computer executable instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions.

In some aspects, a non-transitory computer-readable storage medium may be any medium that can tangibly contain or store computer-executable instructions for use by or in connection with the instruction execution system, apparatus, or device. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may also include, by way of example, a transmission line, and any other suitable medium for transmitting software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Likewise, memory 126 may include high-speed random access memory and may also include non-volatile memory, such as one or more magnetic disk storage devices, flash memory devices, or other non-volatile solid-state memory devices. A corresponding memory controller may control access to memory 126 by other components of network entity 120 and/or one or more modules, servers, and/or components of network entity 120. Executable instructions for performing these functions are, optionally, included in a transitory computer-readable storage medium or other computer program product configured for execution by one or more processors.

Referring to FIG. 1B, network entity 120 may include one or more components, servers, and/or modules configured to process, manage and report expense information. For example, network entity 120 may be configured, via one or more modules, to receive expense and/or transaction information and generate one or more expense and/or transaction data objects using the expense and/or transaction information for use in subsequent expense and/or transaction processing. Specifically, the processing may encompass various aspects including, but not limited to, data normalization including, but not limited to, merchant identifiers, as well as duplicate analysis of one or more transaction data objects.

In some aspects, one or more modules/components of network entity 120, and more specifically, message queuing cluster 132, may be configured to perform one or both of an autonomous expense procedure. In some aspects, the data normalization aspects and the duplicate analysis aspects may form or otherwise be part of the autonomous expense procedure. For example, the autonomous expense procedure may be a procedure that receives and analyzes one or more expense and/or transaction data objects to determine whether to adjust a set of valid expense data used in expense processing and management. Further, the autonomous expense procedure may be based or operate according to, at least in part, a string distance procedure according to:

D(s,t)=c/Max(|s |, |t|) (1)

where s is the first string, t is the second string, and c equals the count of characters that s and t have in common.

In some aspects, enterprise service bus 132-6 (FIG. 1B) may be a hardware and/or software architecture model facilitating communication between mutually interacting hardware and/or software applications in a service-oriented architecture. As depicted in FIG. 1B, these backend servers of the message queuing cluster 132 may include web interface module 132-1, identity module 132-2, web interface module 132-3, client API module 132-4, and web notification module 132-5 may be coupled/connected to or otherwise in communication with enterprise service bus 132-6.

Each module may function asynchronously and perform specific autonomous functions within or as part of network entity 120. For example, web interface module 132-1 may be configured to provide a web browser user interface wherein user account-based access to network entity 120 may be initiated. Further, identity module 132-2 may be configured to provide user identity management and may establish relationships between or among user accounts and one or more company/organization accounts in addition to granting access to other systems and/or platforms across the Internet that may share similar user authentication protocols.

Web interface module 132-3 may be configured to provide a user interface, which may grant user access to network entity 120 via, for example, a web browser, which in turn may provide platform-independent access to network entity 120 via the world wide web. Client API module 132-4 may be configured to grant access to network entity 120 for a select group of external applications. For example, these external applications may include one or more native mobile applications and/or one or more accounting system parameter translation module providers installed on computing devices to communicate with accounting software (e.g., desktop translation module). Web notification module 132-5 may be configured to provide a method for delivering messages to web browsers, native mobile applications, and accounting software (e.g., desktop translation module via Comet protocol).

In addition, access service modules 144 may also include modules with specific processing capabilities that are coupled to or connected to enterprise service bus 132-6. For instance, the expanded service modules forming part of access service modules 144 may include, but are not limited to: receipt processing module 144-1, first credit card transaction processing module 144-2, asynchronous web operations module 144-3, first external synchronization module 144-4, flat-file export module 144-5, second external synchronization module 144-6, identity store cleanup module 144-7, auto categorization module 144-8, identity emailing module 144-9, outbound email notification module 144-10, periodic job scheduling module 144-11, web notification routing module 144-12, report state management module 144-13, entity sync status module 144-14, progress management module 144-15, third external synchronization module 144-16, fourth external synchronization module 144-17, second credit card transaction processing module 144-18, credit card reassignment module 144-19, billing module 144-20, and approval routing module 144-21.

In some aspects, receipt processing module 144-1 may be configured to initiate optical recognition (e.g., via optical character recognition), request turking from a service to read transactional data from a receipt image, determine a confidence level for duplicate receipts, and accommodate multi-page images and one or more file types (e.g., portable document format (PDF)). Additionally, receipt processing module 144-1 may be configured to perform the autonomous expense procedure (e.g., machine learning operations according to string distance procedures) to determine a confidence level for duplicate receipts.

First credit card transaction processing module 144-2 may be configured to determine the integration with one or more transaction card (e.g., credit card) data aggregation module providers with one or more credit card module providers. In some aspects, first credit card transaction processing module 144-2 may be configured to obtain an integration level between the network entity 120 and a data storage entity (e.g., a data aggregation module provider and/or a transaction card module provider).

Asynchronous web operations module 144-3 may be configured to control and/or direct various asynchronous operations in order to optimize throughput. In some aspects, asynchronous web operations module 144-3 may be configured to accept a websites' long-running tasks such that the web site may continue to perform other operations. In such instances, the parameters of completed asynchronous operations may be delivered via the web notification module 132-5. For example, asynchronous operations may include, but are not limited to, policy calculations on one or more expenses, entity hierarchy checks, and/or analytics parameter generation.

External synchronization modules 144-4, 144-6, 144-16, and 144-17 may be configured to integrate features of the network entity 120 to an integrated accounting service. Additionally, flat file export module 144-5 may be configured to determine and extract data from database 152 and generate a data file according to a specified format (e.g., comma-delimited, pdf, html). Further, identity store cleanup module 144-7 may be configured to provide offline processing of identities (e.g., user accounts and/or company enterprise accounts).

Auto categorization module 144-8 may be configured to perform, for example, an expense categorization or category estimation procedure. For example, auto categorization module 144-9 may be configured to perform an expense category estimation procedure for one or more expense data objects based in part on a categorization probability associated with each of the one or more expense data objects. Additionally, auto categorization module 144-8 may be configured to perform the autonomous expense procedure (e.g., machine learning operations) to adjust or update a set of expense data, for instance, in accordance with performing the expense category estimation procedure.

Identity emailing module 144-9 may be configured to provide email notifications based, at least in part, on user identity management, such as signup flows. Outbound e-mail notification module 144-10 may be configured to control or direct the sending of emails as needed by network entity 120. Further, periodic job scheduling module 144-11 may be configured to determine or otherwise produce schedule-based activities, including, for example, periodic (e.g., hourly, daily, weekly) synchronizations.

Web notification routing module 144-12 may be configured to bridge the enterprise service bus 132-6 and the web notification module 132-5 to provide communication directly to the browser in real-time. In some aspects, report state management module 144-13 may be configured to control or direct states of expense reports while, for example, an export is in progress.

Entity sync status module 144-14 may be configured to control or direct entity changes. In some instances, changes to an expense parameter and/or a set of expense data used as part of the autonomous expense procedure of the network entity 120 may be routed by entity sync status module 144-14 to an appropriate synchronization module for delivery of the change to each synchronized target system. It should be appreciated that one or more messages provided on or by the enterprise service bus 132-6 may be made available for consumption, acquisition, reception by any one of the external sync modules (e.g., entity sync status module 144-14).

Progress management module 144-15 may be configured to collect and monitor, for example, completion of a variety of synchronization modules and may provide user interface (UI) information pertaining to one or more synchronization modules.

Second credit card transaction processing module 144-18 may be configured to enable parsing of credit card transaction files that may be manually uploaded to network entity 120 in lieu of a credit card transaction accessed via first credit card transaction processing module 144-2. In some aspects, receipt processing module 144-1 may be configured to perform a merchant identity procedure including identifying, extracting and modifying (erg., removing) data pertinent in receipt or invoice data.

Credit card reassignment module 144-19 may be configured to redirect and process expenses across identities from a credit card setup by a first user via the first credit card transaction processing module 144-2 or second credit card transaction processing module 144-18 to a second user. In some aspects, billing module 144-20 may be configured to receive and/or provide billing information to network entity 120. Further, approval routing module 144-21 may be configured to support submission of expense reports and may control or direct approval routing processing.

In some aspects, an advantage of coupling or connecting the backend servers and modules to enterprise service bus 132-6 is that the modules in the message queuing cluster 132 may communicate via a message queuing pattern in enterprise service bus 132-6. In some instances, the enterprise service bus 132-6 may automatically distribute messages from module-to-module based, at least in part, upon a message's usage throughout the network entity 120. Further. the enterprise service bus 132-6 may be configured to grant durable delivery of those messages across the private access entity 122, thereby replicating the messages across multiple machines and increasing likelihood of delivery in the instance of a failure of one or more processing entities in the private access entity 122.

A further advantage of coupling or connecting the backend servers and modules to enterprise service bus 132-6 may be that each server and module operates relatively independently to transmit and receive adjustments/updates to and from central enterprise service bus 132-6. That is, the modules may function as independent elements of the message queuing cluster 132 that may perform individual functions that may not depend on other modules (e.g., a first module that does not depend on operations of a second module to perform a specific function). This results in an asynchronous interaction between modules and servers in any permutation and combination to synergistically form a highly configurable expense processing, reporting, and management system.

Additionally, the interconnectivity of servers and modules with specific processing capabilities facilitates a service-oriented architecture. This results in a highly scalable architecture as the interconnectivity supports or otherwise enables the reduction or addition of servers and modules to accommodate specific processing capabilities of network entity 120

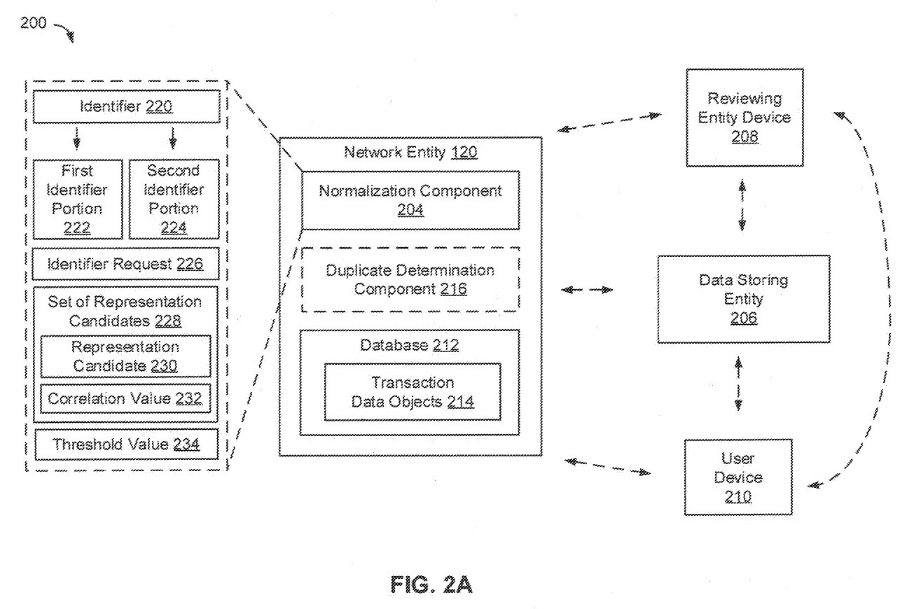

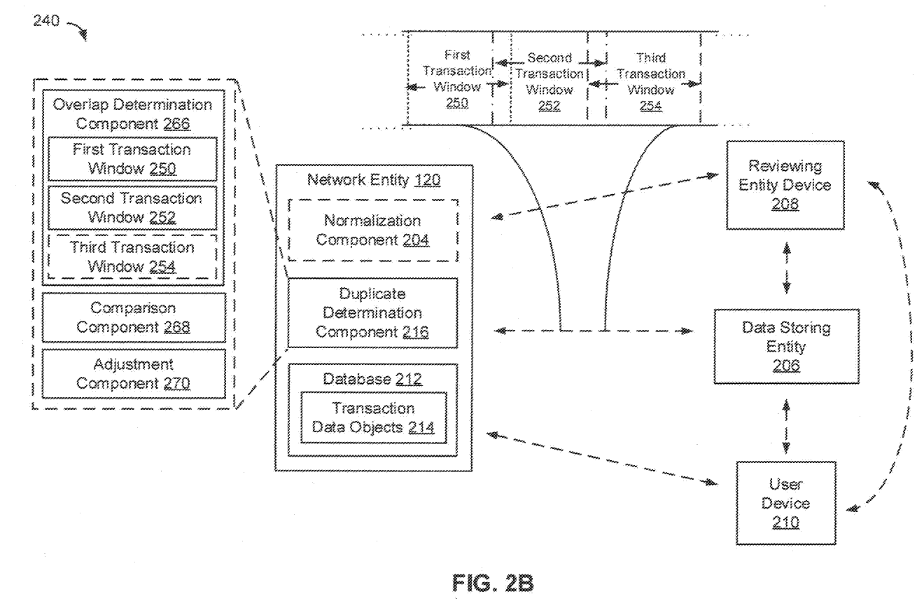

Referring to FIG. 2A, a communication system 200 includes network entity 120 that communicates and/or interfaces with data storing entity 206, reviewing entity device 208, and user device 210. In some aspects, each of reviewing entity 206 and user device 210 may be the same as or similar to one of client devices 102, 104, and 106. Communication system 200 may facilitate expense information transfer, processing, reporting, and management via, for example, network entity 120.

In particular, network entity 120 may be configured to process and manage received transaction data in order to resolve identifier 220. Network entity 120 may include normalization component 204 configured to parse (e.g., identifier 220), query, and select one or more representation candidates (e.g., representation candidate 230). That is, network entity 120 may execute normalization component 204 to receive identifier 220 (e.g., as part of the data object) from reviewing entity device 208, data storing entity 206, and/or user device 210 and manipulate identifier 220 to identify one or more representation candidates (e.g., representation candidate 230).

Identifier 220 may include one or more characters of a string, a phrase, and/or symbols that is divisible into one or more identifier portions (e.g., first identifier portion 222 and/or second identifier portion 224) according to one or more partitioning parameters (e.g., delimiter, string tokenizer). For example, identifier 220 may be a string with one or more embedded words (e.g., tokens) delimited using one or more delimiting characters such as numerals, commas, spaces, tabs, semicolons, and the like. It should be appreciated that the one or more embedded words are not limited to a single delimiter, but may include two or more delimited characters.

Network entity 120 may also execute normalization component 204 to send identifier request 226 (e.g., query) to database 152 (e.g., normalized database) to retrieve a set of normalized identifiers. In some instances, identifier 226 request may include one or more identifier portions (e.g., first identifier portion 222 and/or second identifier portion 224) and a request instruction (e.g., Boolean operator). In response to sending identifier request 226 (e.g., query) to database 152 (e.g., normalized database), network entity 120 may execute normalization component 204 to receive a set of representation candidates 228 from the set of normalized identifiers within database 212 (e.g., which may be the same as or similar to database 152, FIG. 1A).

Network entity 120 and/or normalization component 204 may implement various techniques to determine whether one or more representation candidates from the set of representation candidates 228 accurately reflects an identifier among a set of identifiers. For instance, with respect to representation candidate 230, network entity 120 may execute normalization component 204 to determine correlation value 232 (e.g., confidence value) for representation candidate 230 (e.g., and for each additional representation candidate) from the set of representation candidates 232 and determine whether correlation value 232 of representation candidate 230 meets or exceeds threshold value 234. The threshold value represents a minimum accepted degree of confidence that the representation is the correct/accurate identifier among a set of identifiers.

In this instance network entity 120 may execute normalization component 204 to either select representation candidate 230 based on a determination that one correlation value 232 of representation candidate 230 meets or exceeds threshold value 234 or forgo selection of the representation candidate 230 based on a determination that correlation value 232 of representation candidate 230 does not meet or exceed threshold value 234. It should be appreciated that the identifiers (e.g., identifier 220) are not limited to a single class of transaction objects 214 but may include a merchant identifier, a location identifier, a transaction amount identifier, and/or a time identifier.

Referring to FIG. 2B, a communication system 240 includes network entity 120 that communicates and/or interfaces with data storing entity 206, reviewing entity device 208, and user device 210. Periodic updates between network entity 120 and storing entity 206, reviewing entity device 208, and user device 210 may result in duplicate instances of transaction data objects 214. The periodic updates may include transaction data objects 214 that span overlapping transaction windows (e.g., overlaps in time domain). For example, three periodic updates (e.g., each including a set of transaction data objects) may include a first transaction window 250 that overlaps a second transaction window 252 and a third transaction window 254 that overlaps the second transaction window 252.

For transactions that originate from one or more transaction sources such as data storing entity 206 illustrated in FIG. 2B, the transaction data objects 214 of the overlapping transaction windows may include duplicate transaction data objects that may be identified so as not to include redundant transaction data objects in the transaction data object history stored in database 212. Transaction data objects 214 may include transaction data objects from first transaction window 250, second transaction window 252, and/or third transaction window 254. As such, network entity 120 includes duplicate determination component 216, which may be configured, via overlap determination component 266, to determine whether one or more transaction data objects received within one transaction window (e.g., first transaction window 250) is a duplicate of another transaction data object received within another transaction window (e.g., second transaction window 252).

In some instances, transaction data objects 214 from a single transaction source may include pending transactions and are subject to change between one or more identifiers (e.g., identifier 220) and/or between a first transaction window 250 and a second transaction window 252. For example, a pending credit card transaction identified in the first transaction window 250 may have an inaccurate time identifier that places the exact transaction on a separate day from the ‘settled’ transaction card transaction identified in the second transaction window 252.

As such, duplicate determination component 216 of network entity 120 may be configured to receive a first set of transaction data objects 214 corresponding to first transaction window 250 and a second set of transaction data objects 214 corresponding to second transaction window 252, which may overlap at least a portion of the first transaction window 250, and determine, via overlap determination component 266, that the ‘pending’ transaction data object from the first set of transaction data objects that falls within the overlapping portion is not present in the second set of transaction data objects 214. In some aspects, duplicate determination component 216 may be configured to identify the ‘settled’ transaction data object within the second set of transaction data objects (e.g., within the second transaction window 252) and the one or more non-overlapping portions.

Additionally, in some aspects, overlap determination component 266 may include comparison component 268, which may be configured to determine whether one or more transaction characteristics (e.g., aggregator, transaction source, date, and/or time) of a first transaction data object matches one or more transaction characteristics of a second transaction data object stored in database 212 of network entity 120 and received from one or more second transaction sources (e.g., data storing entity 206). Overlap determination component 266 may include adjustment component 270, which may be configured to adjust one or more properties of an expense record (e.g., that was generated after receiving first transaction data object) associated with the second transaction data object according to the one or more transaction characteristics of the first transaction data object based on determining that one or more transaction characteristics of the first transaction data object matches one or more transaction characteristics of the second transaction data object.

For instance, the expense record may include one or more properties corresponding to a date, merchant identifier, amount value, a link or association to a particular transaction data object. A transaction data object may include one or more transaction characteristics similar to the one or more properties of the expense record (e.g., date, merchant identifier, amount value) and/or a flag indication representing a trigger for initiating a search for another transaction data object to associate with the expense record. That is, the flag indication may represent a determination that the transaction data object does not satisfy (e.g., meet or exceed) a data object to expense record association threshold representing a sufficient level of similarity (e.g., confidence) between the one or more characteristics of the transaction data object and the one or more properties of the expense record.

Further, in some aspects, duplicate determination component 216 may include adjustment component 270, which may be configured to adjust at least an association of the expense record previously associated with a ‘pending’ transaction data object (e.g., from a first set of transaction data objects) to a ‘settled’ transaction data object (e.g., from a second set of transaction data objects) and/or by adjusting one or more characteristics/properties (e.g., date identifier, time identifier, merchant identifier) of the expense record based on one or more distinct characteristics of the ‘settled’ transaction data object (e.g., a characteristic present/detected in the ‘settled’ transaction data that is not present/detected in the ‘pending’ transaction data, such as, a distinct date, a distinct amount, and/or a distinct merchant name).

In some aspects, duplicate determination component 216 of network entity 120 is not limited a single transaction data object or identifier and that there may be differences between one or more transaction data objects or identifiers in the between transaction data 214 of the first transaction window 250 and transaction data 214 of the second transaction window 252. In some aspects, matching performed by duplicate determination component 216 may not be limited to a single source but may be applied to one or more data transaction sources. For example, periodic updates from each source of the one or more data transaction sources may be aggregated in a manner that overlaps transaction windows from multiple data transaction sources. That is, the one or more transaction windows may be each received from distinct transaction sources (e.g., receiving data entity 208, data storing entity 206, and/or user device 210).

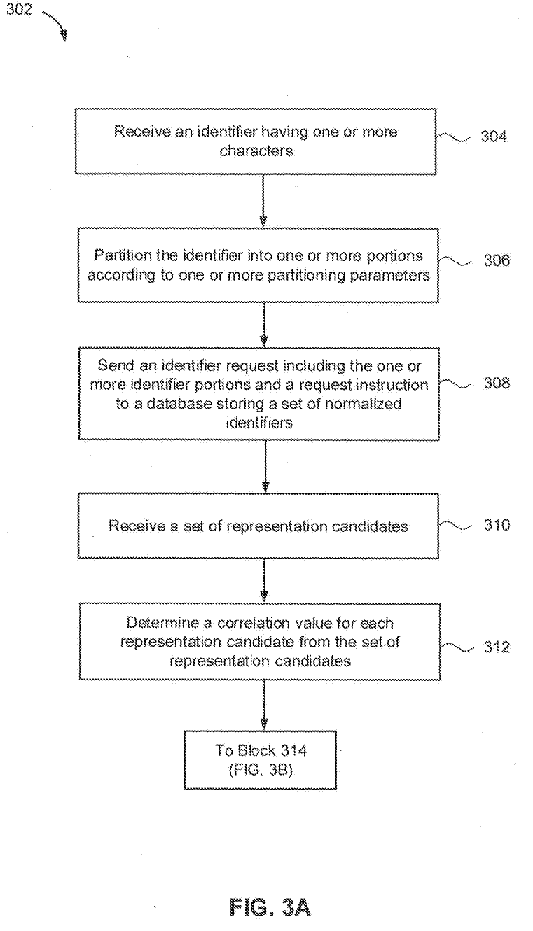

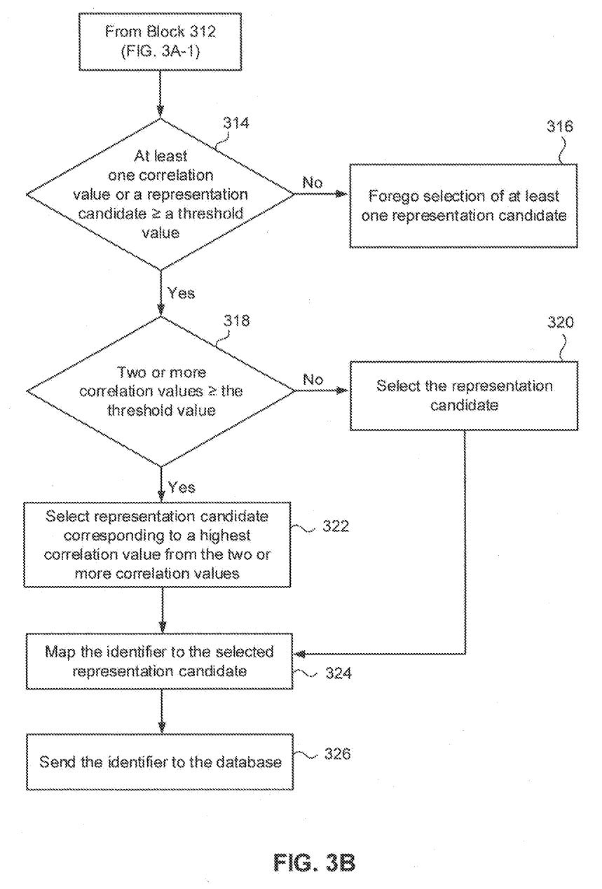

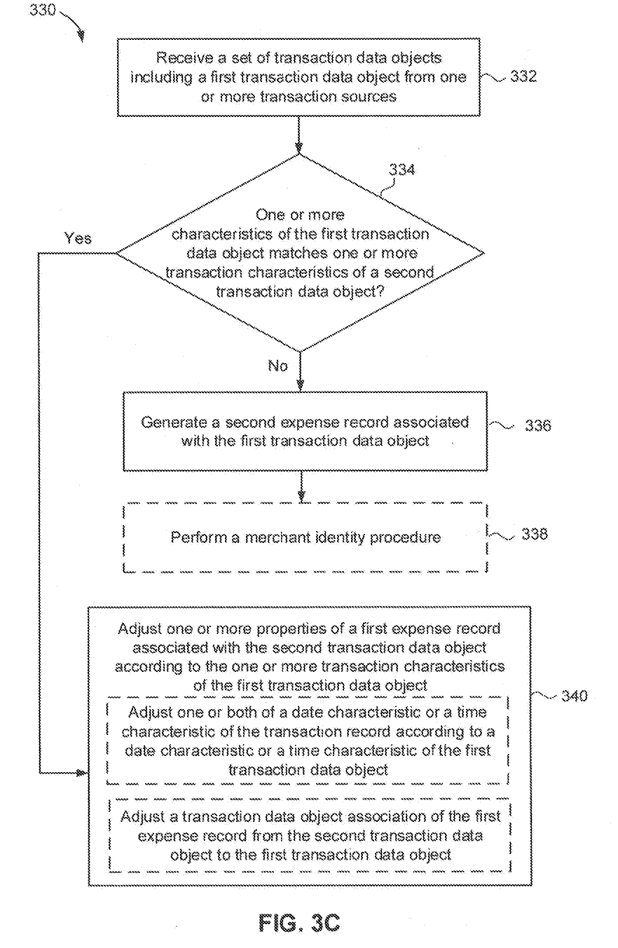

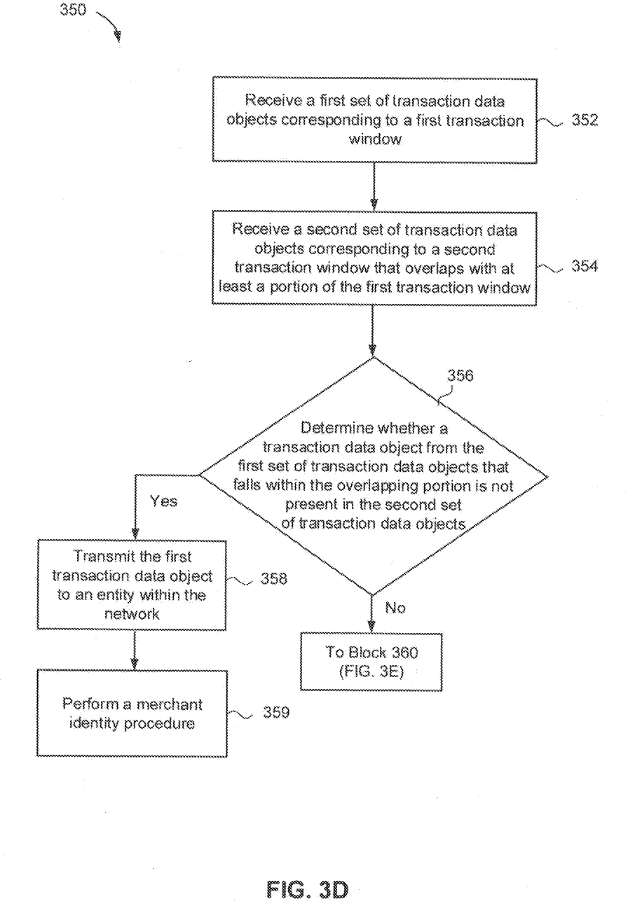

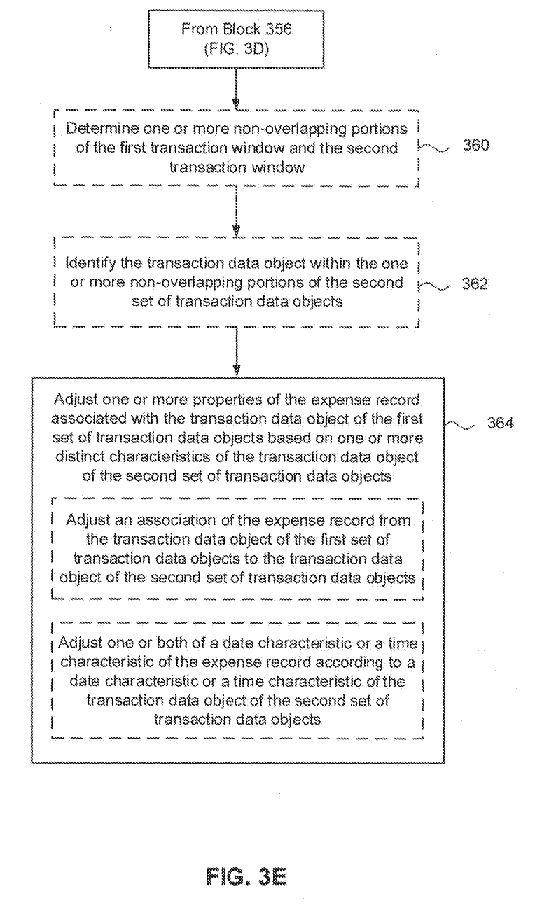

Referring to FIGS. 3A and 3B, example operations of an aspect of network entity 120 (FIGS. 1 and 2) including normalization component 204 (FIG. 2) according to the present apparatus and methods are described with reference to one or more methods and one or more components that may perform the actions of these methods. Specifically, method 302 provides for normalizing a data object such as, but not limited to, a merchant identifier. Although the operations described below are presented in a particular order and/or as being performed by an example component, it should be understood that the ordering of the actions and the components performing the actions may be varied, depending on the implementation. Moreover, it should be understood that the following actions or components described with respect to the normalization component 204 (FIG. 2) and/or its subcomponents may be performed by a specially-programmed processor, a processor executing specially-programmed software or computer-readable media, or by any other combination of a hardware component and/or a software component specially configured for performing the described actions or components.

In an aspect, at block 304, method 302 may receive the identifier having one or more characters. In an aspect, for example, network entity 120 (FIGS. 1 and 2) may be configured to execute one or more modules or components (e.g., normalization component 204, FIG. 2) to receive the identifier having one or more characters. In some aspects, the network entity 120 (FIGS. 1 and 2) may execute normalization component 204 (FIG. 2) to determine whether the identifier is received from a first source or a second source, the first source having a lower confidence level relative to a second source. Further, in some aspects, the identifier may be a merchant identifier having one or more characters.

In an aspect, at block 306, method 302 may partition the identifier into one or more identifier portions according to one or more partitioning parameters. In an aspect, for example, network entity 120 (FIGS. 1 and 2) may be configured to execute one or more modules or components (e.g., normalization component 204, FIG. 2) to partition the identifier (e.g., merchant identifier) into one or more identifier portions (e.g., merchant identifier portions) according to one or more partitioning parameters. In some aspects, partitioning the identifier may include partitioning the identifier into two or more identifier portions (e.g., two or more tokens).

In further aspects, the two or more identifier portions may include a first identifier portion and a second identifier portion. In some aspects, the network entity 120 (FIGS. 1 and 2) may execute normalization component 204 (FIG. 2) to use three identifier portions. In a further aspect, the one or more partitioning parameters may include one or more identification mechanisms (e.g., space, capitalization, etc.). For example, the one or more partitioning parameters may include one or more of a space character, a comma character, a period character, a backslash character, a forward slash character, or a character capitalization.

At block 308, method 302 may send an identifier request including the one or more identifier portions and a request instruction to a database storing a set of normalized identifiers. In an aspect, for example, network entity 120 (FIGS. 1 and 2) may be configured to execute one or more modules or components (e.g., normalization component 204, FIG. 2) to send an identifier request (e.g., query) including the one or more identifier portions (e.g., merchant identifier portions) and a request instruction to a database (e.g., normalized database) storing a set of normalized identifiers. In some aspects, the request instruction may include one or more Boolean operators (e.g., AND, OR, etc.). In further aspects, sending the identifier request may include sending a query to the database.

In an aspect, at block 310, method 302 may receive a set of representation candidates. In an aspect, for example, network entity 120 (FIGS. 1 and 2) may be configured to execute one or more modules or components (e.g., normalization component 204, FIG. 2) to receive a set of representation candidates (e.g., merchant representation candidates) in response to sending the identifier request. In some aspects, network entity 120 may execute normalization component 204 (FIG. 2) to determine a distance value for each representation candidate according to a string distance determination. In some aspects, the set of normalized identifiers include the set of representation candidates, which may be, in some instances, a set of merchant representation candidates.

Further, at block 312, method 302 may determine a correlation value for each representation candidate from the set of representation candidates. In an aspect, for example, network entity 120 (FIGS. 1 and 2) may be configured to execute one or more modules or components (e.g., normalization component 204, FIG. 2) to determine a correlation value (e.g., confidence value) for each representation candidate (e.g., merchant representation candidate) from the set of representation candidates (e.g., set of merchant representation candidates). In some aspects, determining the correlation value for each identifier candidate may include comparing each representation candidate from the set of representation candidates to the identifier based on one or more normalization parameters (e.g., metadata).

In some aspects, the one or more normalization parameters (e.g., metadata) may include one or more of a location information, source information (e.g., of a transaction), amount (e.g., of a transaction), domain name (e.g., of a merchant or of the entity sending the transaction information), email information (e.g., logo within the email indicating the merchant), image information, the identifier (e.g., merchant name following a removal of one or more characters), or a second identifier different from the identifier (e.g., raw merchant name including all characters).

In some aspects, network entity 120 (FIGS. 1 and 2) may execute normalization component 204 (FIG. 2) to decrease a correlation value of one of the representation candidates (e.g., one of the merchant representation candidates) in accordance with a determination that the identifier is received from the first source (e.g., due to a history—defined time period—of poor merchant identifier information received from the source). In further aspects, network entity 120 (FIGS. 1 and 2) may execute normalization component 204 (FIG. 2) to increase the correlation value in accordance with a determination that the identifier is not received from the second source. In a further aspect, method 302 may continue to block 314 (FIG. 3B).

In an aspect, at block 314, method 302 may determine whether at least one correlation value of a representation candidate meets or exceeds a threshold value. In an aspect, for example, network entity 120 (FIGS. 1 and 2) may be configured to execute one or more modules or components (e.g., normalization component 204, FIG. 2) to determine whether at least one correlation value of a representation candidate (e.g., merchant representation candidate) meets or exceeds a threshold value. In some aspects, when network entity 120 (FIGS. 1 and 2) and/or normalization component 204 (FIG. 2) determines that at least one correlation value of a representation candidate does not meet or exceed a threshold value, method 302 may proceed to block 316. In some aspects, however, when network entity 120 and/or normalization component 204 (FIG. 2) determines that at least one correlation value of a representation candidate meets or exceeds a threshold value, method 302 may proceed to block 318 or in some aspects, may forego block 318 and select the representation candidate having the at least one correlation value that meets or exceeds the threshold value.

At block 316, method 302 may forgo selection of at least one representation candidate based on determining that at least one correlation value of the representation candidate does not meet or exceed the threshold value. In an aspect, for example, network entity 120 (FIGS. 1 and 2) may be configured to execute one or more modules or components (e.g., normalization component 204, FIG. 2) to forgo selection of at least one representation candidate (e.g., merchant representation candidate) based on determining that at least one correlation value of the representation candidate does not meet or exceed the threshold value.

Further, at block 318, method 302 may determine whether two or more correlation values meet or exceed the threshold value. In an aspect, for example, network entity 120 (FIGS. 1 and 2) may be configured to execute one or more modules or components (e.g., normalization component 204, FIG. 2) to determine whether two or more correlation values meet or exceed the threshold value. In some aspects, when network entity 120 (FIGS. 1 and 2) and/or normalization component 204 (FIG. 2) determines that two or more correlation values do not meet or exceed the threshold value, method 302 may proceed to block 320. Nonetheless, when network entity 120 (FIGS. 1 and 2) and/or normalization component 204 (FIG. 2) determines that two or more correlation values meet or exceed the threshold value, then method 302 may proceed to block 322.

For example, at block 320, method 302 may select the representation candidate based on determining that the two or more correlation values do not meet or exceed the threshold value. In an aspect, for example, network entity 120 (FIGS. 1 and 2) may be configured to execute one or more modules or components (e.g., normalization component 204, FIG. 2) to select the representation candidate (e.g., merchant representation candidate) based on determining that two or more correlation values do not meet or exceed the threshold value.

Moreover, at block 322, method 302 may select a representation candidate corresponding to a highest correlation value from the two or more correlation values based on determining that the two or more correlation values meet or exceed the threshold value. In an aspect, for example, network entity 120 (FIGS. 1 and 2) may be configured to execute one or more modules or components (e.g., normalization component 204, FIG. 2) to select a representation candidate (e.g., merchant representation candidate) corresponding to a highest correlation value from the two or more correlation values based on determining that the two or more correlation values meet or exceed the threshold value.

At block 324, method 302 may map the identifier to the selected representation candidate. In an aspect, for example, network entity 120 (FIGS. 1 and 2) may be configured to execute one or more modules or components (e.g., normalization component 204, FIG. 2) to map the identifier to the selected representation candidate (e.g., having the highest correlation value). In an aspect, at block 326, method 302 may send the identifier to the database. In an aspect, for example, network entity 120 (FIGS. 1 and 2) may be configured to execute one or more modules or components (e.g., normalization component 204, FIG. 2) to send the identifier to the database. Further, in some aspects, the correlation value may be automatically adjusted based on one or more of a user input or the one or more normalization parameters (e.g., increased frequency in user edits results in tuning the threshold or correlation value to a higher value/level).

Referring to FIG. 3C, example operations of an aspect of network entity 120 (FIGS. 1 and 2) including duplicate determination component 206 (FIG. 2) according to the present apparatus and methods are described with reference to one or more methods and one or more components that may perform the actions of these methods. Specifically, method 330 provides for determining potential duplicate transaction data objects and adjusting previously stored expense records associated with one or more transaction data objects based on such determinations. Although the operations described below are presented in a particular order and/or as being performed by an example component, it should be understood that the ordering of the actions and the components performing the actions may be varied, depending on the implementation. Moreover, it should be understood that the following actions or components described with respect to the duplicate determination component 206 (FIG. 2) and/or its subcomponents may be performed by a specially-programmed processor, a processor executing specially-programmed software or computer-readable media, or by any other combination of a hardware component and/or a software component specially configured for performing the described actions or components.

In an aspect, at block 332, method 330 may receive a set of transaction data objects including a first transaction data object from one or more first transaction sources. In an aspect, for example, network entity 120 (FIGS. 1 and 2) may be configured to execute one or more modules or components (e.g., duplicate determination component 206, FIG. 2) to receive a set of transaction data objects 214 (FIG. 2B) including a first transaction data object from one or more first transaction sources (e.g., file upload, third party provider, and/or an aggregation entity). In some aspects, each transaction data object of the set of transaction data objects includes one or more transaction characteristics.

Further, in some aspects, the one or more transaction characteristics of the first transaction data object corresponds to a first aggregation entity and the one or more transaction characteristics of the second transaction data object corresponds to a second aggregation entity. In further aspects, receiving the set of transaction data objects from the one or more transaction sources may include receiving a first portion of the set of transaction data objects from one of the one or more first transaction sources and a second portion of the set of transaction data objects from another one of the one or more transaction sources. In some aspects, the set of transaction data objects is associated with a transaction card account, and each transaction data object of the set of the transaction data objects is associated with a credit or debit card transaction.

In an aspect, at block 334, method 330 may determine whether one or more transaction characteristics of the first transaction data object matches one or more transaction characteristics of a second transaction data object stored in a database of the network entity and received from one or more second transaction sources. In an aspect, for example, network entity 120 (FIGS. 1 and 2) including duplicate determination component 206 (FIG. 2) may be configured to execute one or more modules or components (e.g., comparison component 268, FIG. 2) to determine whether one or more transaction characteristics (e.g., aggregator, transaction source, date, and/or time) of the first transaction data object matches one or more transaction characteristics of a second transaction data object stored in a database of the network entity and received from one or more second transaction sources.

In some aspects, the one or more transaction characteristics of the first transaction data object corresponds to one or both of a first date or a first time value of a transaction occurrence associated with the first transaction data object and the one or more transaction characteristics of the second transaction data object corresponds to one or both of a second date or a second time value of a transaction occurrence associated with the second transaction data object. In a further aspect, one or both of the first date or the first time value of the first transaction data object is distinct from (e.g., is greater, occurs after) one or both of the second date or the second time value of the second transaction data object.

In some aspects, determining whether one or more transaction characteristics of the first transaction data object matches one or more transaction characteristics of the second transaction data object may include determining that the second transaction data object is not detected within a portion (e.g., overlapping or non-overlapping portion) of the set of transaction data objects; and identifying the first transaction data object as similar to the second transaction data object based on the one or more transaction characteristics. In further aspects, the one or more transaction characteristics of the first transaction data object corresponds to a first merchant characteristic (e.g., merchant data/identifier) representing a posted transaction and the one or more transaction characteristics of the second transaction data object corresponds to a second merchant characteristic (e.g., merchant data/identifier) different from the first merchant characteristic and representing a pending transaction. In some aspects, the second transaction data object represents a pending transaction associated with a transaction card account and the first transaction data object represents a posted transaction associated with the transaction card account.

In an aspect, at block 336, method 330 may generate a second expense record associated with the first transaction data object. In an aspect, for example, network entity 120 (FIGS. 1 and 2) may be configured to execute one or more modules or components (e.g., duplicate determination component 206, FIG. 2) to generate a second expense record associated with the first transaction data object. In some aspects, upon generating the second expense record, method 330 may transmit the second expense record to an entity (e.g., a component of FIG. 2B) within the network.

In an aspect, at block 338, method 330 may perform a merchant identity procedure. In an aspect, for example, network entity 120 (FIGS. 1 and 2) may be configured to execute one or more modules or components (e.g., duplicate determination component 206, FIG. 2) to perform a merchant identity procedure (e.g., character scrubbing procedure) on the first merchant identifier of the expense data object to obtain a second merchant identifier associated with the expense data object based on a determination that the expense data object includes the transaction source indication.

In some aspects, the transaction source information includes one or more of optical character recognition information associated with the merchant identifier, a credit card indication representing merchant identifier information received from a remote credit card entity, or a manual indication representing merchant identifier information received directly from a user. For example, the optical character recognition information may represent merchant identifier information received from a remote entity and includes one or more of an initial correlation value (e.g., estimation of how likely the OCR entity got the merchant name correct), an initial merchant identifier, and/or a date.

In accordance with some aspects, performing the merchant identity procedure may include modifying (e.g., removing) a portion of the first merchant identifier based on one or more filtering characteristics to obtain the second merchant identifier. Specifically, the merchant identity procedure may include determining that a portion of the first merchant identifier includes one or more characters qualifying for removal. In some aspects, as part of the determination, the merchant identity procedure may identify one or more portions of the first merchant identifier for removal. Additionally, the second merchant identifier may be stored while maintaining a record of the first merchant identifier.

In accordance with some aspects, the one or more filtering characteristics may include one or both of a readability characteristic or a character repetition characteristic. Further, the merchant identity procedure may be based, at least in part, on human readability and/or repeating characters. For instance, in some aspects, the merchant identity procedure may erase or hide extraneous tracking or contact information. In some aspects, the merchant identity procedure may remove extraneous characters and/or text of the first merchant identifier.

In an example not to be construed as limiting, a string of characters forming the first merchant identifier (and part of the expense data object) may be received from transaction card providers (e.g., aggregated credit card data provider) or an uploaded transaction file (e.g., expense data including one or more expense data objects). For instance, the first merchant identifier may include the string “****Merchant???**”, where the characters adjacent the term “Merchant” may be considered extraneous and not part of the merchant name or identifier. The merchant identity procedure may identify and remove substrings or portions of the received string based on one or more filtering characteristics including rules identified from patterns across transaction file merchant strings.

In some aspects, the substrings may include cities, states, asterisks, store numbers, phone numbers, or other extraneous characters not part of the merchant identifier. As such, the merchant identity procedure may identify the extraneous sub strings in “****Merchant???** to obtain the second merchant identifier including the modified string “Merchant”. Further, network entity 120 may store a record of both the original string of the first merchant identifier and the modified string forming the second merchant identifier.

In an aspect, at block 340, method 330 may adjust one or more properties of a first expense record associated with the second transaction data object according to the one or more transaction characteristics of the first transaction data object. In an aspect, for example, network entity 120 (FIGS. 1 and 2) including duplicate determination component 206 (FIG. 2) may be configured to execute one or more modules or components (e.g., adjustment component 206, FIG. 2B) to adjust one or more properties of a first expense record associated with the second transaction data object according to the one or more transaction characteristics of the first transaction data object. In some aspects, adjusting one or more properties of a first expense record associated with the second transaction data object according to the one or more transaction characteristics of the first transaction data object may include adjusting one or both of a date characteristic or a time characteristic of the first expense record according to a date characteristic or a time characteristic of the first transaction data object. In some aspects, adjusting the one or more properties of the first expense record associated with the second transaction data object according to the one or more transaction characteristics of the first transaction data object includes adjusting a transaction data object association of the first expense record from the second transaction data object to the first transaction data object.

For example, the first expense record may be created or generated by network entity 120 (FIGS. 1 and 2) upon receiving the second transaction data object (e.g., which may have been received sequentially prior to the first transaction data object). In some aspects, the first expense record may include at least a portion of the information forming or included within a transaction data object. For instance, the first expense record may include one or more properties corresponding to a date, merchant identifier, amount value, a link or association to a particular transaction data object. In some aspects, a transaction data object from the set of transaction data objects may include one or more transaction characteristics similar to the one or more properties of the first expense record (e.g., date, merchant identifier, amount value) and/or a flag indication representing a trigger for initiating a search for another transaction data object to associate with the first expense record. That is, the flag indication may represent a determination that the transaction data object does not satisfy (e.g., meet or exceed) a data object to expense record association threshold representing a sufficient level of similarity (e.g., confidence) between the one or more characteristics of the transaction data object and the one or more properties of the expense record. The one or more properties may also include metadata from or associated with a transaction data object. As such, in some aspects, adjusting the one or more properties of the first expense record may include adjusting or modifying an association or link (e.g., adjusting a pointer, a linked data structure, and/or a reference to or between the first expense record and a particular transaction data object).

Referring to FIGS. 3D and 3E, example operations of an aspect of network entity 120 (FIGS. 1 and 2) including duplicate determination component 206 (FIG. 2) according to the present apparatus and methods are described with reference to one or more methods and one or more components that may perform the actions of these methods. Specifically, method 350 provides for comparing snapshots and locating duplicate transactions. Although the operations described below are presented in a particular order and/or as being performed by an example component, it should be understood that the ordering of the actions and the components performing the actions may be varied, depending on the implementation. Moreover, it should be understood that the following actions or components described with respect to the duplicate determination component 206 (FIG. 2) and/or its subcomponents may be performed by a specially-programmed processor, executing specially-programmed software or computer-readable media, or by any other combination of a hardware component and/or a software component specially configured for performing the described actions or components.

In an aspect, at block 352, method 350 may receive a first set of transaction data objects corresponding to a first transaction window. In an aspect, for example, network entity 120 (FIGS. 1 and 2) may be configured to execute one or more modules or components (e.g., duplicate determination component 206, FIG. 2) to receive a first set of transaction data objects corresponding to a first transaction window. In some aspects, the first transaction window may include a first transaction window date and a second transaction window date later than the first transaction window date. In some aspects, the transaction data object may be associated with a source characteristic corresponding to one or both of a transaction processor or a location of an underlying transaction of the transaction data object.

In an aspect, at block 354, method 350 may receive a second set of transaction data objects corresponding to a second transaction window that overlaps at least a portion of the first transaction window. In an aspect, for example, network entity 120 (FIGS. 1 and 2) may be configured to execute one or more modules or components (e.g., duplicate determination component 206, FIG. 2) to receive a second set of transaction data objects corresponding to a second transaction window that overlaps at least a portion of the first transaction window. In some aspects, the second transaction window may include a third transaction window date prior to the first transaction window date of the first transaction window and a fourth transaction window date after the first transaction window date and prior to the second transaction window date of the first transaction window.

In a further aspect, the overlapping portion may be between the third transaction window date and the second transaction window date. In some aspects, the transaction data object of the first set of transaction data objects may represent a pending transaction associated with a transaction card account and the transaction data object of the second set of transaction data objects represents a posted transaction associated with the transaction card account. Further, in an aspect, the first set of transaction data objects and the second set of transaction data objects may be associated with a single transaction card account. In some aspects, each transaction data object of the first set of the transaction data objects and the second set of transaction data objects may be associated with a credit or debit card transaction.

At block 356, method 350 may determine whether a transaction data object from the first set of transaction data objects that falls within the overlapping portion is not present in the second set of transaction data objects. In an aspect, for example, network entity 120 (FIGS. 1 and 2) including duplicate determination component 206 (FIG. 2) may be configured to execute one or more modules or components (e.g., overlap determination component 266, FIG. 2B) to determine whether a transaction data object from the first set of transaction data objects that falls within the overlapping portion is not present in the second set of transaction data objects. In some aspects, determining whether the transaction data object from the first set of transaction data objects that falls within the overlapping portion is not present in the second set of transaction data objects may include determining based on one or more source characteristics associated with the transaction data object.

In an aspect, at block 358, method 350 may transmit the first transaction data object to an entity within the network. In an aspect, for example, network entity 120 (FIGS. 1 and 2) may be configured to execute one or more modules or components (e.g., duplicate determination component 206, FIG. 2) to transmit the first transaction data object to an entity within the network.

In an aspect, at block 359, method 350 may perform a merchant identity procedure. In an aspect, for example, network entity 120 (FIGS. 1 and 2) may be configured to execute one or more modules or components (e.g., duplicate determination component 206, FIG. 2) to perform a merchant identity procedure (e.g., character scrubbing procedure) on the first merchant identifier of the expense data object to obtain a second merchant identifier associated with the expense data object based on a determination that the expense data object includes the transaction source indication.

In an aspect, at block 360, method 350 may optionally determine one or more non-overlapping portions of the first transaction window and the second transaction window. In an aspect, for example, network entity 120 (FIGS. 1 and 2) may be configured to execute one or more modules or components (e.g., duplicate determination component 206, FIG. 2) to determine one or more non-overlapping portions of the first transaction window 250 (FIG. 2B) and the second transaction window 252 (FIG. 2B).

In an aspect, at block 362, method 350 may optionally identify the transaction data object within the one or more non-overlapping portions of the second set of transaction data objects. In an aspect, for example, network entity 120 (FIGS. 1 and 2) may be configured to execute one or more modules or components (e.g., duplicate determination component 206, FIG. 2) to identify the transaction data object within the one or more non-overlapping portions of the second set of transaction data objects. In some aspects, identifying the transaction data object may include identifying based on one or more transaction characteristics including a date indication, a time indication, and/or a merchant identifier. Further, in some aspects, identifying the transaction data object may include determining whether the transaction data object is identified/detected within the one or more non-overlapping portions of the second set of transaction data objects. If the transaction data object has been identified (e.g., based on the one or more transaction characteristics) within the one or more non-overlapping portions of the second set of transaction data objects, method 350 may proceed to block 364. However, if the transaction data object has not been identified within the one or more non-overlapping portions of the second set of transaction data objects, method 350 may, an expense record may be generated and associated with the transaction object.

In an aspect, at block 364, method 350 may adjust one or more properties of the expense record associated with the transaction data object of the first set of transaction data objects based on one or more distinct characteristics of the transaction data object of the second set of transaction data objects. In an aspect, for example, network entity 120 (FIGS. 1 and 2) may be configured to execute one or more modules or components (e.g., duplicate determination component 206, FIG. 2) to adjust one or more properties of the expense record associated with the transaction data object of the first set of transaction data objects based on one or more distinct characteristics of the transaction data object of the second set of transaction data objects.

In some aspects, the one or more properties of the expense record may include a date indication, a time indication, and/or merchant info. Specifically, in some aspects, adjusting the one or more properties of the expense record associated with the transaction data object of the first set of transaction data objects may include adjusting one or both of a date characteristic or a time characteristic of the expense record according to a date characteristic and/or a time characteristic of the transaction data object of the second set of transaction data objects. That is, the date characteristic and/or the time characteristic of the expense record may be updated to reflect the corresponding date characteristic and/or time characteristic of the transaction data object of the second set of transaction data objects. In some aspects, the date characteristic and the time characteristic may each be distinct from a date characteristic and a time characteristic each associated with the transaction data object of the first set of transaction data objects. Further, in some aspects, adjusting the one or more properties of the expense record associated with the transaction data object of the first set of transaction data objects may include adjusting an association of the expense record from the transaction data object of the first set of transaction data objects to the transaction data object of the second set of transaction data objects.

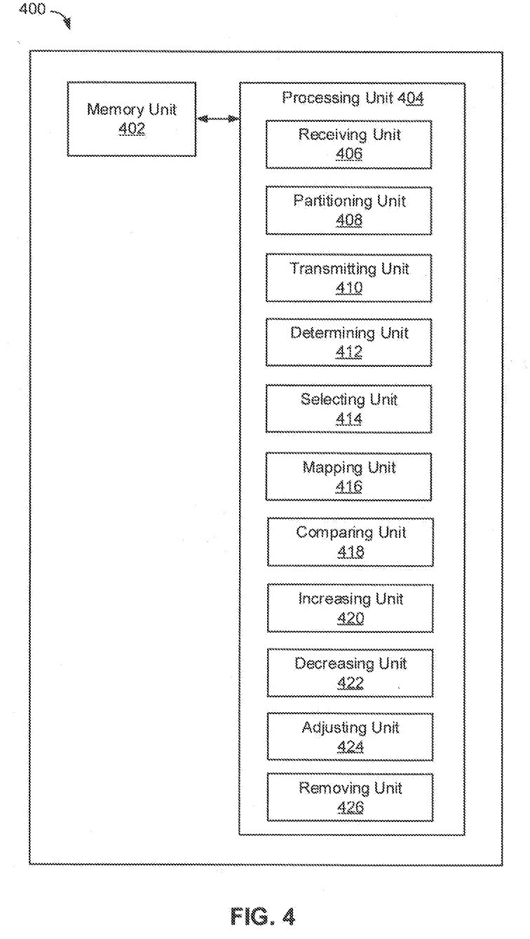

In accordance with some aspects, FIGS. 4-6 show example functional block diagrams of an electronic devices 400, 500, and 600 configured in accordance with the principles of the various described aspects. In accordance with some aspects, the functional blocks of electronic devices 400, 500, and 600 are configured to perform the techniques described herein. The functional blocks of electronic device 400, 500, and 600 are, optionally, implemented by hardware, software, or a combination of hardware and software to carry out the principles of the various described examples. It is understood by persons of skill in the art that the functional blocks described in FIGS. 4-6 are optionally combined or separated into sub-blocks to implement the principles of the various described examples. Therefore, the description herein optionally supports any possible combination or separation or further definition of the functional blocks described herein.

As shown in FIG. 4, an electronic device 400, which may be the same as or similar to network entity 120 (FIGS. 1A and 1B) includes memory unit 402, which may be configured to store data for retrieval, and processing unit 404 coupled to the memory unit 402. In some aspects, processing unit 404 includes receiving unit 406, partitioning unit 408, transmitting unit 410, determining unit 412, selecting unit 414, and mapping unit 416.

Processing unit 404 may be configured to receive (e.g., via receiving unit 406) the identifier (e.g., merchant identifier) having one or more characters; partition (e.g., via partitioning unit 408) the identifier into one or more identifier portions (e.g., merchant identifier portions) according to one or more partitioning parameters; send (e.g., via transmitting unit 410) including the one or more identifier portions and a request instruction (e.g., merchant identifier request) to a database storing a set of normalized identifiers; receive (e.g., via receiving unit 406) a set of representation candidates (e.g., merchant representation candidates) in response to sending the identifier request, the set of normalized identifiers may include the set of representation candidates; determine (e.g., via determining unit 412) a correlation value for each representation candidate from the set of representation candidates; determine (e.g., via determining unit 412) whether at least one correlation value of a representation candidate meets or exceeds a threshold value (e.g., merchant threshold value); select (e.g., via selecting unit 414) the representation candidate (e.g., merchant representation candidate) based on determining that at least one correlation value of the representation candidate meets or exceeds the threshold value; and forego selection (e.g., via selecting unit 414) of at least one representation candidate based on determining that at least one correlation value of the representation candidate does not meet or exceed the threshold value.

In accordance with some aspects, processing unit 404 may be configured to determine (e.g., using or via determining unit 412) whether two or more correlation values meet or exceed the threshold value; and select (e.g., via or using selecting unit 414) a representation candidate corresponding to a highest correlation value from the two or more correlation values based on determining that the two or more correlation values meet or exceed the threshold value.

In accordance with some aspects, to determine the correlation value for each identifier candidate, processing unit 404 may be configured to compare (e.g., using or via comparing unit 418) each representation candidate from the set of representation candidates to the identifier based on one or more normalization parameters.

In accordance with some aspects, the one or more normalization parameters include one or more of location information, source information, amount, domain name, email information, image information, the identifier, or a second identifier different from the identifier.

In accordance with some aspects, the transaction source information includes one or more of: optical character recognition information associated with the merchant identifier, the optical character recognition information represents merchant identifier information received from a remote entity and includes one or more of an initial correlation value, an initial merchant identifier, or a date; a credit card indication representing merchant identifier information received from a remote credit card entity; or a manual indication representing merchant identifier information received directly from a user.

In accordance with some aspects, processing unit 404 may be configured to map (e.g., using or via mapping unit 416) the identifier to the selected representation candidate; and send (e.g., using or via transmitting unit 410) the identifier to the database.

In accordance with some aspects, processing unit 404 may be configured to automatically adjust (e.g., using or via adjusting unit 424) the correlation value based on one or more of a user input or the one or more normalization parameters.

In accordance with some aspects, processing unit 404 may be configured to determine (e.g., using or via determining unit 412) whether the identifier is received from a first source or a second source, the first source having a lower confidence level relative to a second source; decrease (e.g., using or via decreasing unit 422) a correlation value of one of the representation candidates in accordance with a determination that the identifier is received from the first source; and increase (e.g., using or via increasing unit 420) the correlation value in accordance with a determination that the identifier is not received from the second source.

In accordance with some aspects, to determine the distance value for each representation candidate, processing unit 404 may be configured to determine (e.g., using or via determining unit 412) the distance value according to a string distance determination.

In accordance with some aspects, the one or more characters of the merchant identifier are fewer or greater in number than one or more characters of the normalized merchant representation.

In accordance with some aspects, to partition the identifier, processing unit 404 may be configured to partition (e.g., using or via partitioning unit 408) the identifier into two or more identifier portions.

In accordance with some aspects, to partitioning the merchant identifier, processing unit 404 may be configured to partition (e.g., using or via partitioning unit 408) the merchant identifier into two or more merchant identifier portions including a first identifier portion and a second identifier portion.

In accordance with some aspects, the one or more partitioning parameters include one or more identification mechanisms.

In accordance with some aspects, the one or more partitioning parameters include one or more of a space character, a comma character, a period character, a backslash character, a forward slash character, or a character capitalization.

In accordance with some aspects, the request instruction includes one or more Boolean operators.

In accordance with some aspects, to receive the merchant identifier, processing unit 404 may be configured to receive (e.g., using or via receiving unit 406) an initial merchant identifier having one or more initial characters from an expense submitting entity; and remove (e.g., using or via removing unit 426) a portion of the one or more initial characters of the initial merchant identifier to obtain the merchant identifier.

In accordance with some aspects, to send the identifier request, processing unit 404 may be configured to send (e.g., using or via transmitting unit 410) a query to the database.

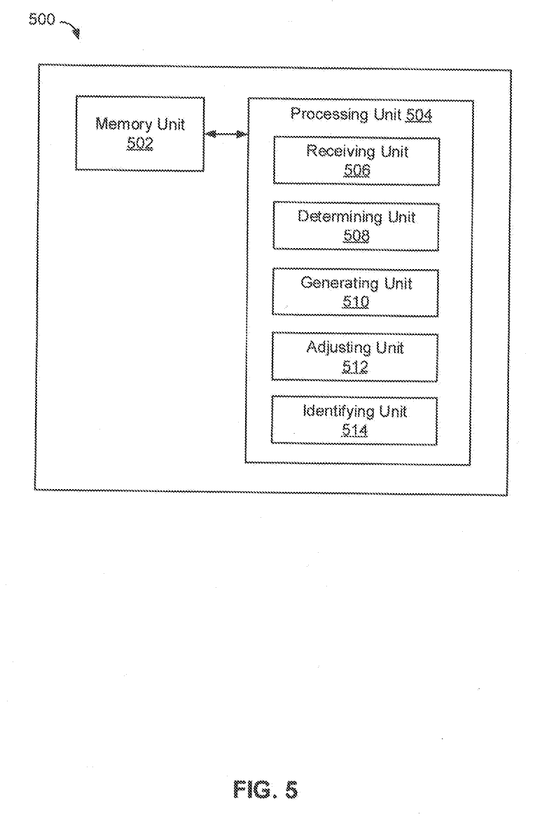

As shown in FIG. 5, an electronic device 500, which may be the same as or similar to network entity 120 (FIGS. 1A and 1B) includes memory unit 502, which may be configured to store data for retrieval, and processing unit 504 coupled to the memory unit 502. In some aspects, processing unit 504 includes receiving unit 506, determining unit 508, generating unit 510, adjusting unit 512, and identifying unit 514.

Processing unit 504 may be configured to receive (e.g., via receiving unit 506) at a network entity, a set of transaction data obj ects including a first transaction data object from one or more first transaction sources, each transaction data object of the set of transaction data objects may include one or more transaction characteristics; determine (e.g., via determining unit 508) at the network entity, whether one or more transaction characteristics of the first transaction data object matches one or more transaction characteristics of a second transaction data object stored in a database of the network entity and received from one or more second transaction sources; in accordance with a determination that one or more transaction characteristics of the first transaction data object matches one or more transaction characteristics of the second transaction data object, adjust (e.g., via adjusting unit 512) one or more properties of an first expense record associated with the second transaction data object according to the one or more transaction characteristics of the first transaction data object; and in accordance with a determination that one or more transaction characteristics of the first transaction data object does not match one or more transaction characteristics of the second transaction data object, generating (e.g., via generating unit 510) a second expense record associated with the first transaction data object.

In accordance with some aspects, the one or more transaction characteristics of the first transaction data object corresponds to one or both of a first date or a first time value of a transaction occurrence associated with the first transaction data object and the one or more transaction characteristics of the second transaction data object corresponds to one or both of a second date or a second time value of a transaction occurrence associated with the second transaction data object.

In accordance with some aspects, one or both of the first date or the first time value of the first transaction data object is distinct from one or both of the second date or the second time value of the second transaction data object.

In accordance with some aspects, to adjust one or more properties of a first expense record associated with the second transaction data object according to the one or more transaction characteristics of the first transaction data object, processing unit 504 may be configured to adjust (e.g., using or via adjusting unit 512) one or both of a date characteristic or a time characteristic of the first expense record object according to a date characteristic or a time characteristic of the first transaction data object.

In accordance with some aspects, to adjust the one or more properties of the first expense record associated with the second transaction data object according to the one or more transaction characteristics of the first transaction data object, processing unit 504 may be configured to adjust (e.g., using or via adjusting unit 512) a transaction data object association of the first expense record from the second transaction data object to the first transaction data object.

In accordance with some aspects, the one or more transaction characteristics of the first transaction data object corresponds to a first aggregation entity and the one or more transaction characteristics of the second transaction data object corresponds to a second aggregation entity.

In accordance with some aspects, to determine whether one or more transaction characteristics of the first transaction data object matches one or more transaction characteristics of the second transaction data object, processing unit 504 may be configured to determine (e.g., using or via determining unit 508) that the second transaction data object is not detected within a portion of the set of transaction data objects in an overlapping portion of the first transaction window and the second transaction window; and identify (e.g., using or via identifying unit 514) the first transaction data object as similar to the second transaction data object outside the overlapping portion based on the one or more transaction characteristics.

In accordance with some aspects, the one or more transaction characteristics of the first transaction data object corresponds to a first merchant characteristic representing a posted transaction and the one or more transaction characteristics of the second transaction data object corresponds to a second merchant characteristic different from the first merchant characteristic and representing a pending transaction.

In accordance with some aspects, to receive the set of transaction data objects from the one or more transaction sources, processing unit 504 may be configured to receive (e.g., using or via receiving unit 506) a first portion of the set of transaction data objects from one of the one or more first transaction sources and a second portion of the set of transaction data objects from another one of the one or more transaction sources.

In accordance with some aspects, the second transaction data object represents a pending transaction associated with a transaction card account and the first transaction data object represents a posted transaction associated with the transaction card account.

In accordance with some aspects, the set of transaction data objects is associated with a transaction card account.

In accordance with some aspects, each transaction data object of the set of the transaction data objects is associated with a credit or debit card transaction.

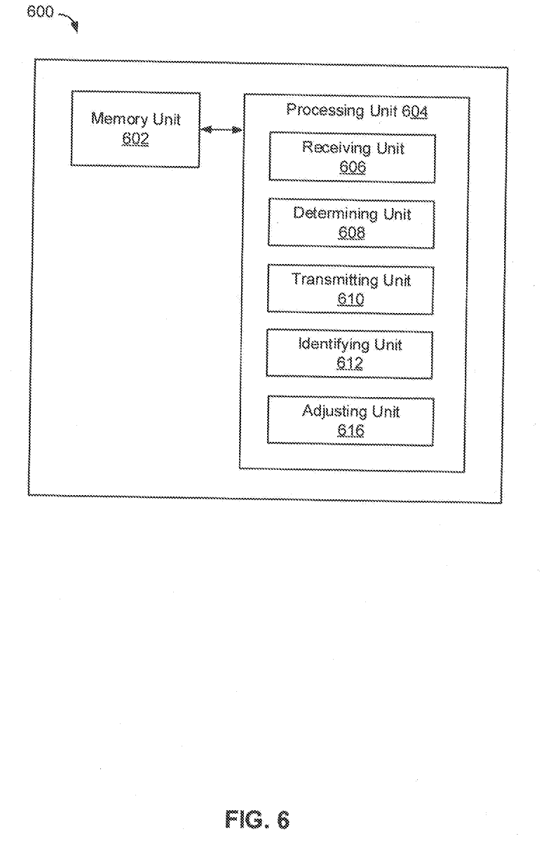

As shown in FIG. 6, an electronic device 600, which may be the same as or similar to network entity 120 (FIGS. 1A and 1B) includes memory unit 602, which may be configured to store data for retrieval, and processing unit 604 coupled to the memory unit 602. In some aspects, processing unit 604 includes receiving unit 606, determining unit 608, transmitting unit 610, identifying unit 612, merging unit 614, adjusting unit 616.

Processing unit 604 may be configured to receive (e.g., via receiving unit 606) at a network entity within a network, a first set of transaction data objects associated with a first transaction window; receive (e.g., via receiving unit 606) at the network entity, a second set of transaction data objects associated with a second transaction window that overlaps at least a portion of the first transaction window; determine (e.g., via determining unit 608) at the network entity, whether a transaction data object from the first set of transaction data objects that falls within the overlapping portion is not present in the second set of transaction data objects; and in accordance with a determination that the transaction data object from the first set of transaction data objects that falls within the overlapping portion is present in the second set of transaction data objects, transmit (e.g., via transmitting unit 610) the first transaction data object to an entity within the network; and adjust (e.g., via adjusting unit 616) one or more properties of the expense record associated with the transaction data object of the first set of transaction data objects based on one or more distinct characteristics of the transaction data object of the second set of transaction data obj ects.

In accordance with some aspects, processing unit 604 may be configured to, in accordance with a determination that the transaction data object from the first set of transaction data objects that falls within the overlapping portion is not present in the second set of transaction data objects, determine (e.g., via determining unit 608) one or more non-overlapping portions of the first transaction window and the second transaction window, and identify (e.g., via identifying unit 612) the transaction data object within the one or more non-overlapping portions of the second set of transaction data objects.

In accordance with some aspects, to adjust the one or more properties of the expense record associated with the transaction data object of the first set of transaction data objects, processing unit 604 may be configured to adjust (e.g., using or via adjusting unit 616) one or both of a date characteristic or a time characteristic of the expense record according to a date characteristic or a time characteristic of the transaction data object of the second set of transaction data objects.

In accordance with some aspects, the date characteristic and the time characteristic are each distinct from a date characteristic and a time characteristic each associated with the transaction data object of the first set of transaction data objects.

In accordance with some aspects, to adjust the one or more properties of the expense record associated with the transaction data object of the first set of transaction data objects, processing unit 604 may be configured to adjust (e.g., using or via adjusting unit 616) an association of the expense record from the transaction data object of the first set of transaction data objects to the transaction data object of the second set of transaction data objects.

In accordance with some aspects, the first transaction window includes a first transaction window date and a second transaction window date later than the first transaction window date.

In accordance with some aspects, the second transaction window includes a third transaction window date prior to the first transaction window date of the first transaction window and a fourth transaction window date after the first transaction window date and prior to the second transaction window date of the first transaction window.

In accordance with some aspects, the overlapping portion is between the third transaction window date and the second transaction window date.

In accordance with some aspects, the transaction data object is associated with a source characteristic corresponding to one or both of a transaction processor or a location of an underlying transaction of the transaction data object.

In accordance with some aspects, in order to determine whether the transaction data object from the first set of transaction data objects that falls within the overlapping portion is not present in the second set of transaction data objects, processing unit 604 may be configured to determine (e.g., using or via determining unit 608) based on one or more source characteristics associated with the transaction data object.

In accordance with some aspects, the transaction data object of the first set of transaction data objects represents a pending transaction associated with a transaction card account and the transaction data object of the second set of transaction data objects represents a posted transaction associated with the transaction card account.

In accordance with some aspects, the first set of transaction data objects and the second set of transaction data objects are associated with a single transaction card account.

In accordance with some aspects, each transaction data object of the first set of the transaction data objects and the second set of transaction data objects is associated with a credit or debit card transaction.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of resolving one or more expense records at a network entity, comprising:
receiving, at the network entity, a set of transaction data objects including a first transaction data object from one or more first transaction sources, wherein each transaction data object of the set of transaction data objects includes one or more transaction characteristics;
determining, at the network entity, whether one or more transaction characteristics of the first transaction data object matches one or more transaction characteristics of a second transaction data object stored in a database of the network entity and received from one or more second transaction sources;
in accordance with a determination that one or more transaction characteristics of the first transaction data object matches one or more transaction characteristics of the second transaction data object, adjusting one or more properties of a first expense record associated with the second transaction data object according to the one or more transaction characteristics of the first transaction data object; and
in accordance with a determination that one or more transaction characteristics of the first transaction data object does not match one or more transaction characteristics of the second transaction data object, generating a second expense record associated with the first transaction data obj ect.

2. The method of claim 1, wherein the one or more transaction characteristics of the first transaction data object corresponds to one or both of a first date or a first time value of a transaction occurrence associated with the first transaction data object and the one or more transaction characteristics of the second transaction data object corresponds to one or both of a second date or a second time value of a transaction occurrence associated with the second transaction data object.

3. The method of claim 2, wherein one or both of the first date or the first time value of the first transaction data object is distinct from one or both of the second date or the second time value of the second transaction data object.

4. The method of claim 2, wherein adjusting one or more properties of the first record associated with the second transaction data object according to the one or more transaction characteristics of the first transaction data object includes adjusting one or both of a date characteristic or a time characteristic of the transaction record according to a date characteristic or a time characteristic of the first transaction data object.

5. The method of claim 1, wherein the one or more properties of the first expense record includes a transaction data object association corresponding to a link between the first expense record and a transaction data object, and wherein adjusting the one or more properties of the first expense record associated with the second transaction data object according to the one or more transaction characteristics of the first transaction data object includes adjusting a transaction data object association of the first expense record from the second transaction data object to the first transaction data object.

6. The method of claim 1, wherein the one or more transaction characteristics of the first transaction data object corresponds to a first aggregation entity and the one or more transaction characteristics of the second transaction data object corresponds to a second aggregation entity.

7. The method of claim 1, wherein determining whether one or more transaction characteristics of the first transaction data object matches one or more transaction characteristics of the second transaction data object includes:
determining that the second transaction data object is not detected within a portion of the set of transaction data objects; and
identifying the first transaction data object as similar to the second transaction data object based on the one or more transaction characteristics.

8. The method of claim 1, wherein the one or more transaction characteristics of the first transaction data object corresponds to a first merchant characteristic representing a posted transaction and the one or more transaction characteristics of the second transaction data object corresponds to a second merchant characteristic different from the first merchant characteristic and representing a pending transaction.

9. The method of claim 1, wherein receiving the set of transaction data objects from the one or more transaction sources includes receiving a first portion of the set of transaction data objects from one of the one or more first transaction sources and a second portion of the set of transaction data objects from another one of the one or more transaction sources.

10. The method of claim 1, wherein the second transaction data object represents a pending transaction associated with a transaction card account and the first transaction data object represents a posted transaction associated with the transaction card account.

11. The method of claim 1, wherein the set of transaction data objects is associated with a transaction card account.

12. The method of claim 1, wherein each transaction data object from the set of the transaction data objects is associated with a credit or debit card transaction.

13. A computer-readable storage medium comprising one or more programs for execution by one or more processors of an electronic device, the one or more programs including instructions which, when executed by the one or more processors, cause the electronic device to:
receive a set of transaction data objects including a first transaction data object from one or more first transaction sources, wherein each transaction data object of the set of transaction data objects includes one or more transaction characteristics;
determine whether one or more transaction characteristics of the first transaction data object matches one or more transaction characteristics of a second transaction data object stored in a database of the network entity and received from one or more second transaction sources;
in accordance with a determination that one or more transaction characteristics of the first transaction data object matches one or more transaction characteristics of the second transaction data object, adjust one or more properties of a first expense record associated with the second transaction data object according to the one or more transaction characteristics of the first transaction data object; and
in accordance with a determination that one or more transaction characteristics of the first transaction data object does not match one or more transaction characteristics of the second transaction data object, generate a second expense record associated with the first transaction data obj ect.

14. The computer-readable storage medium of claim 13, wherein the one or more transaction characteristics of the first transaction data object corresponds to one or both of a first date or a first time value of a transaction occurrence associated with the first transaction data object and the one or more transaction characteristics of the second transaction data object corresponds to one or both of a second date or a second time value of a transaction occurrence associated with the second transaction data object.

15. An apparatus for resolving one or more expense records, comprising:
a memory configured to store data; and
at least one processor communicatively coupled to the memory, wherein the at least one processor is configured to:
receive a set of transaction data objects including a first transaction data object from one or more first transaction sources, wherein each transaction data object of the set of transaction data objects includes one or more transaction characteristics;
determine whether one or more transaction characteristics of the first transaction data object matches one or more transaction characteristics of a second transaction data object stored in a database of the network entity and received from one or more second transaction sources;
in accordance with a determination that one or more transaction characteristics of the first transaction data object matches one or more transaction characteristics of the second transaction data object, adjust one or more properties of a first expense record associated with the second transaction data object according to the one or more transaction characteristics of the first transaction data object; and
in accordance with a determination that one or more transaction characteristics of the first transaction data object does not match one or more transaction characteristics of the second transaction data object, generate a second expense record associated with the first transaction data obj ect.

16. The apparatus of claim 15, wherein the one or more transaction characteristics of the first transaction data object corresponds to one or both of a first date or a first time value of a transaction occurrence associated with the first transaction data object and the one or more transaction characteristics of the second transaction data object corresponds to one or both of a second date or a second time value of a transaction occurrence associated with the second transaction data object.

17. The apparatus of claim 16, wherein one or both of the first date or the first time value of the first transaction data object is distinct from one or both of the second date or the second time value of the second transaction data object.

18. The apparatus of claim 16, wherein to adjust one or more properties of the first expense record associated with the second transaction data object according to the one or more transaction characteristics of the first transaction data object, the at least one processor is further configured to adjust one or both of a date characteristic or a time characteristic of the transaction record according to a date characteristic or a time characteristic of the first transaction data object.

19. The apparatus of claim 15, wherein to adjust the one or more properties of the first expense record associated with the second transaction data object according to the one or more transaction characteristics of the first transaction data object, the at least one processor is further configured to adjust a transaction data object association of the first expense record from the second transaction data object to the first transaction data object.

20. The apparatus of claim 15, wherein the one or more transaction characteristics of the first transaction data object corresponds to a first aggregation entity and the one or more transaction characteristics of the second transaction data object corresponds to a second aggregation entity.
